(19) United States
(12) Patent Application Publication
(10) Pub. No.: US 2022/0069765 A1
(43) Pub. Date: Mar. 3, 2022

(54) Dynamic building-integrated photovoltaics (dbipv) using solar trees and solar sails and the like

(71) Applicant: Antoine Marcel PAULUS, Surrey (CA)

(72) Inventor: Antoine Marcel PAULUS, Surrey (CA)

(21) Appl. No.: 17/416,025

(22) PCT Filed: Dec. 20, 2019
(86) PCT No.: PCT/CA2019/000173

§ 371 Date: Jun. 18, 2021

Related U.S. Application Data
(60) Provisional application No. 62/782,936, filed on Dec. 20, 2018.

(51) Int. Cl. H02S 30/20; H02S 10/12; H02S 20/26; F03D 9/00; F03D 9/32

(52) U.S. Cl. CPC H02S 30/20; H02S 10/12; A62C 37/40; F03D 9/007; F03D 9/32; H02S 20/26

(57) ABSTRACT

An apparatus for converting solar energy to electrical energy comprises at least a central trunk or stem, preferably extending from a base, wherein the base can be attached to a stationary structure like a wall or a house or a garage or a bridge or wherein the base can be part of a mobile device having wheels and at least one or exactly one branch and preferably multiple branches connected to the central trunk or stem, wherein at least or exactly a first branch comprises one or more photovoltaic panels. Additionally, or alternatively comprises a second branch one or more photovoltaic panels. Each of the photovoltaic panels of the first branch preferably comprises one or more sheets of photovoltaic material and preferably one or more anchors for attaching the sheets of photovoltaic material to the first branch.

### BACKGROUND OF THE INVENTION

In a few years, many in the world will be switching to electric vehicles, and this will lead to a major and serious surge in the need and demand for electrical energy. In addition, California's new energy code mandates solar panels on roofs of all new building by 2020, which will have an effect on the design and aesthetics of buildings to a certain extent.

Currently, solar farms are being built in an attempt to replace or supplement the power generated using conventional, traditional power stations, but these farms are also resulting in the destruction of trees and plants and most likely will negatively affect the environment and increase the amount of CO2 in the atmosphere. This will in turn lead to more desertification and may result in even bigger problems in the long run.

Others have turned to floating solar farms as another option, but these have limitations and can only be deployed where water is present under the appropriate conditions. They are also not mobile, or easily transportable, or deployed, among other potential disadvantages, such as when a fire engulfed a floating solar farm installed in a dam reservoir in Japan in late 2019.

In order to assist in overcoming the looming energy shortage problems, dynamic building integrated photovoltaics (DBIPV) structures, mobile solar trees, and mobile solar sails and others are introduced to bring novel solutions to the production of energy and reduction of desertification in a simple design. They may be static or portable and mobile and avoid the need to remove any plants but rather could be set up next to trees and plants even at times to provide shade while enhancing the architectural and aesthetical designs and aspects of the surroundings. It could also be used as an alternative to solar roof panels where regulations in certain states (such as California) and various countries require or will require by law the installation of solar panels on roofs or buildings.

Further objects of the invention will be apparent from detailed description and claims.

### SUMMARY OF THE INVENTION

The elevated structure is the tree/mast which is a pole, which could be designed in the shape of the trunk of a tree or mast of a boat or other forms (such as origami forms) for aesthetic and practical purposes. This same structure could also be the mobile or static electric vehicle charging station. Similarly, the photovoltaic (PV) panels could be a sheet of material or attached to a sheet of material/fabric or inserted between layers of material or sprayed onto a material or fabric stretched and connected to a number of anchors. Moreover, they may be in the form of layers of horizontally or vertically extended sheets of PV panels to simulate the fronds or branches of a tree or the sails of a boat or others (such as origami designs) and distributed in such fashion so as to avoid overlapping as much as possible to allow the sun rays and the light to filter through each layer while trying to avoid casting shade on each other as much as possible, for maximizing the efficiency of the PV panels, though this may eventually be unnecessary with the progress and development of the transparent and organic PV.

In one embodiment, the panels are extended horizontally in the fashion of tree fronds while the other embodiment they are extended vertically in the fashion of sails of a ship and in another embodiment they are fanned from one side to another either vertically or horizontally or both or also in the various degrees in between to form a fan or bellows of sorts all as outlined in the attached drawings.

In the cases where the PV panels are transparent or have a high degree of translucency, then multiple panels may be stacked in a similar fashion to the multilayered mobile artificial cloud, described in U.S. patent application Ser. No. 15/556,269. The PV panels could also be attached back to back to form a two-sided panel, when possible and required.

The PV panels could be set to extend and deploy with a mechanical and/or hydraulic and/or automatically/electrically controlled and operated system at certain times or when there is light and closes in the absence of any light or when required. It would be closed to keep the PV panels clean and for protection and security purposes or when there is heavy wind or when required to be moved or could remain open and deployed for architectural or other purposes. Another embodiment of the invention could have the panels enclosed within an structure similar to the trunk of the tree, which could also house a telescopic winch and/or type or be of such elements which would extend vertically and deploy the PV panels like the fronds of a tree/sails of a ship all around and at various levels to absorb and convert the sunrays to electricity. The PV panels could be of various sizes and shapes and vary in weight depending on the size and shape and type of PV panels. They could range from about 200 grams per square meter or less to about 3.5 kilogram or a little more per square meter depending on the type of PV panels used. The solar tree/sails could come in various shapes and sizes and colours and configurations and sometimes to fit and merge into the surroundings and elements. The size of the tree/sails could also be directly linked to the energy output required by the structure or the client.

It is also possible to embed a set of batteries and a charging system within the tree trunk/sail or base or any part of the structure, especially when the solar tree/sail is also a mobile electric vehicle charging station, which could then be deployed anywhere around the globe to act as a portable power station for many purposes in addition to charging electric vehicles in remote locations. Moreover, it is already possible to charge batteries remotely without wires and so it should also be possible to beam the energy at the location required without the need for wires or cables.

The solar tree/sail could also be used as standalone power stations for houses and buildings and parks and could replace the need for solar roofs and so could help generate electricity at any location with minimum disruption to the building or the environment or the surrounding. They could be linked or connected to one another to form a larger power station/grid or feed into an existing grid or simply form a grid of their own. Thus, a few solar trees/sails or others in a public park would turn the park into a solar power station but would not alter the outlook or the landscape and similarly could be done in the garden of a house/building. The solar tree/sail can be portable and mobile with a base of flexible material such as plastic or a composite lightweight material which could be filled with water to act as ballast (similar to the barriers used in road construction) to keep the solar tree/sails standing at all times and the water could be drained when it is time to move the tree/sails to another location. The stem of the tree/sail can also be manufactured from composite plastic with high strength or a lightweight strong metal such as aluminum or any other material or/and a combination of all and could be of telescopic elements or layers as shown in the attached drawings.

The solar sails could be formed with a mast and the base could be a boat or shaped like one and again could be made of lightweight material such as plastic or another light and strong material, which could be filled with water to act as ballast and could also house batteries and charging system in the base if needed. The solar sails could also come in various shapes and sizes and used as decorative objects while generating energy and the solar sails could also be fixed on a beach or at sea or even moored to ships or boats or installed on ships and boats to power them or as another form of solar farms but with the advantage of being able to close and open the sails or be moved when needed. They could also be deployed into the sea or ocean to form offshore energy farms. The solar sails are different from the floating solar farms as they have generally vertically deployed panels, thus providing more PV panel area and are lighter and more portable and easier to transport from place to place and can be launched on land or the beach or on the water and like the average sailing boat design the masts could be closed or lowered when required to avoid storms and/or inclement weather.

The solar tree and solar sails and others could be adapted for DBIPV (Dynamic Building Integrated Photo Voltaics) where the mechanical elements excluding perhaps the base could be embedded within a building or a wall or a recess in a wall or any other part of a building or structure or built into the wall or attached to the building or walls or structure at a later stage to enable the fronds or sails or others to open and close at various levels without disturbing the surroundings but in fact they could add to the ambiance and aura of the structure where they could be built in many and various designs and to create living art in buildings as shown in the attached drawings. Various advertising materials could also be added to the panels to generate revenues and could be used for educational or entertainment purposes. This is a novel element of architectural design where live art is incorporated into the architecture.

DBIPV mobile electric vehicle charging stations in the form of mobile solar tree and mobile solar sails could be deployed to any location in the world where there is sufficient sunlight to generate electricity to charge or recharge electric vehicles (EV) thus eliminating the need for EV charging stations to draw from the grid and this will substantially expand the scope for the use of electric vehicles worldwide. Moreover, using floating solar clouds (FSC) on the roofs of large building such as shopping malls and warehouses and connecting them together would create a large solar farm over existing built up areas and avoids having to use any un built land or agricultural land to build solar farms.

The invention brings a quick solution to producing instant energy in sufficient quantities to power schools and hospitals and agricultural pumps in rural areas and in distant locations where electricity is not available and this could also help in controlling forest fires by powering sensors and water pumps as detailed later and also help in disaster areas where power has been affected, where the solar trees/sails and various other DBIPV structures could be linked to provide a grid of any desired size. This will eventually have a serious positive impact on rural society from education to health and agriculture and beyond.

This invention is also a novel approach and addition to architecture, urban, and rural design and planning and where it would eventually be possible to purchase a solar power station at the local hardware store. All the PV panels used with the DBIPV structures may comprise thin and light and flexible photovoltaic material or such, even though in some cases such as DBIPV bellows or floating solar clouds, traditional rigid and heavier PV panels could be used if required.

DBIPV structures will enable buildings to control when and how to deploy the dynamic photovoltaic (PV) panels and also to create changeable and moving artistic designs and murals which could be deployed from the walls or other parts of buildings and other structures when needed and close them as desired thus creating live art in the architecture of any structure. These PV panels could also be turned into visible advertising or artistic designs with lights, sounds and motion during the day and also at sundown and when all goes dark.

The present invention is also directed to an apparatus for converting solar energy to electrical energy, in particularly for use with a stationary structure or a mobile structure. The apparatus preferably comprises at least a central trunk or stem, preferably extending from a base, wherein the base can be attached to a stationary structure like a wall or a house or a garage or a bridge or wherein the base can be part of a mobile device having wheels and at least one or exactly one branch and preferably multiple branches connected to the central trunk or stem, wherein at least or exactly a first branch comprises one or more photovoltaic panels. Additionally, or alternatively comprises a second branch one or more photovoltaic panels. Each of the photovoltaic panels of the first branch preferably comprises one or more sheets of photovoltaic material and preferably one or more anchors for attaching the sheets of photovoltaic material to the first branch. Additionally or alternatively, each of the photovoltaic panels of the second branch comprises preferably one or more sheets of photovoltaic material and preferably one or more anchors for attaching the sheets of photovoltaic material to the second branch. The first branch is preferably coupled via a first joint to the central trunk or stem to be movable with respect to the central trunk or stem and/or the second branch is preferably coupled via a second joint to the central trunk or stem to be movable with respect to the central trunk or stem.

The present invention is also directed to an apparatus for converting solar energy to electrical energy. The apparatus preferably comprises at least a base, a central trunk or stem extending from the base; multiple branches connected to the central trunk or stem, wherein at least a first branch of said multiple branches comprises one or more solar units, in particularly photovoltaic panels, and wherein a second branch of said multiple branches comprises one or more solar units, in particularly photovoltaic panels, wherein each of the solar units of the first branch comprises one or more sheets of photovoltaic material and one or more anchors for attaching the sheets of photovoltaic material to the first branch, and wherein each of the solar units of the second branch comprises one or more sheets of photovoltaic material and one or more anchors for attaching the sheets of photovoltaic material to the second branch, wherein the first branch is coupled via a first joint to the central trunk or stem to be movable with respect to the central trunk or stem and/or wherein the second branch is coupled via a second joint to the central trunk or stem to be movable with respect to the central trunk or stem.

According to a preferred embodiment, the apparatus is a mobile apparatus and wherein the base comprises at least two wheels, in particular at least three or four wheels.

According to a preferred embodiment, the central trunk extends perpendicularly to the base or in an angle between 70° and 110° or in an angle between 85° and 95°.

According to a preferred embodiment, the first joint and the second joint are arranged in the same lower part of central trunk or stem, wherein said lower part has a length of 20% of the axial length of the central trunk or stem, wherein a third joint for connecting a third branch is arranged an upper part of central trunk or stem, wherein said upper part has a length of 20% of the axial length of the central trunk or stem, wherein the lower part is materialized closer to the base compared to the upper part, wherein a further part is materialized between the upper part and the lower part, wherein said further part has a length of at least 5% of the axial length of the central trunk or stem, wherein no further joint is arranged in said further part.

According to a preferred embodiment, the branches are pivotably or hingedly connected to the central trunk and/or wherein the apparatus comprises at least three or at least four branches, wherein the third branch comprises one or more sheets of photovoltaic material and one or more anchors for attaching the sheets of photovoltaic material to the third branch and/or wherein the fourth branch comprises one or more sheets of photovoltaic material and one or more anchors for attaching the sheets of photovoltaic material to the fourth branch.

According to a preferred embodiment, the central trunk comprises an outer wall, wherein the outer wall comprises a plurality of wall segments, wherein the wall segments are configured to telescope within one another.

According to a preferred embodiment, the apparatus further comprises at least two deployment cables extending between the central trunk and two branches, in particularly the first branch and the second branch, wherein one deployment cable connects an upper section of the central trunk or stem with an axial end of one branch and wherein the other deployment cable connects the upper section of the central trunk or stem with an axial end of the other branch, wherein the upper section is materialized on one side of the upper part and wherein the lower part is materialized on the other side of the upper part.

According to a preferred embodiment, the apparatus further comprises a motorized mechanism for moving the branches with respect to the central trunk, wherein an actuator is connected to one or multiple or all of the deployment cables, wherein the actuator moves one or multiple or all deployment cables in response to an operation of an motor, wherein the motor is arranged at the central trunk or stem or on or in the base.

According to a preferred embodiment, the central trunk or stem further comprises a central reinforcement rod, wherein the central reinforcement rod is configured to be telescoping.

According to a preferred embodiment, the sheets of photovoltaic material are at least sectionally non-destructively bendable or foldable due to elastic properties or one or more bending sections and/or one or more folding sections.

According to a preferred embodiment, the sheets of photovoltaic material are thinner than 5 cm or 3 cm or 1 cm or 0.5 cm.

According to a preferred embodiment, the sheets of photovoltaic material have a weight of less than 10 kg per m² or of less than 5 kg per m² or of less than 1 kg per m² or of less than 0.5 kg per m².

According to a preferred embodiment, the apparatus comprises one or more sleeves, wherein each sleeve is configured to hold one or more of the one or more photovoltaic panels, wherein at least one sleeve is attached to the first branch and wherein another sleeve or the same sleeve is attached to another branch, in particular the second branch or the third branch.

According to a preferred embodiment, the branches are configured to be foldable such that the photovoltaic panels form one or more bellows, wherein at least two branches comprise joints in a central section of branches, wherein each central section is materialized between a first axial end and a second axial end of the respective branch.

According to a preferred embodiment, the apparatus comprises a security system connected to one or more of the base, central trunk and/or branch/es, wherein the security system comprises a satellite based position detection unit (e.g. GPS or Galileo) and a communication unit, wherein the communication unit transmits position data outputted by the position detection unit via a wireless network (e.g. GSM or LTE or WLAN) to a pre-defined recipient, in particular server.

According to a preferred embodiment, the base is at least sectionally and preferably completely hollow.

According to a preferred embodiment, the apparatus further comprises a weather system respectively a weather detecting system, wherein the weather system effects the movement of the branches based, at least in part, on the weather, wherein the weather system comprises at least one sensor unit, wherein the sensor unit comprises at least a wind sensor and/or a heat sensor and/or a light sensor and/or fire sensor or smoke detector and/or a motion sensor, in particular an acceleration sensor, in particular a multi axis acceleration sensor, in particular a three axis acceleration sensor, wherein the sensor unit is arranged at the central trunk or stem or at the base or at one of the branches, or wherein the weather system comprises multiple sensor units, wherein each of the sensor units comprises at least a wind sensor and/or a heat sensor and/or fire sensor or smoke detector and/or a light sensor and/or a motion sensor, in particular an acceleration sensor, in particular a multi axis acceleration sensor, in particular a three axis acceleration sensor, or wherein some of the sensor units comprise at least a wind sensor and/or a heat sensor and/or fire sensor or smoke detector and/or a light sensor and/or a motion sensor, in particular an acceleration sensor, in particular a multi axis acceleration sensor, in particular a three axis acceleration sensor, and wherein the apparatus comprises a control unit, wherein the control unit processes the sensor data of the sensor unit or of multiple sensor units or of all sensor units and/or operates the motor to move at least one deployment cable.

According to a preferred embodiment, the apparatus comprises an actuator for rotating the central trunk or stem, wherein said actuator is arranged at the central trunk or stem and/or at the base, wherein the actuator is coupled with the motor or with another motor, wherein the control unit operates the motor or the other motor to actuate the actuator for rotating the central trunk or stem in dependency of the sensor data.

According to a preferred embodiment, the apparatus comprises one or more wind turbines for generating electricity from wind power, wherein the one or more wind turbines are arranged on the base or on or below branches, wherein the wind turbine/s generates electric energy, wherein the wind turbine/s is/are connected via a conductor with the same battery or outputting device for outputting the electric energy from the apparatus to a grid or further device as the photovoltaic panels, wherein the battery and/or the outputting device is/are part of the apparatus.

According to a preferred embodiment, the apparatus comprises a water sprinkler system.

According to a preferred embodiment, the apparatus further comprises a firefighting system, wherein the base comprises a reservoir for providing a medium, in particularly foam or liquid or powder for extinguishing fire, wherein the reservoir is connected to a conduit system of the apparatus, wherein the conduit system comprises at least one conduit which extends at least sectionally along the central trunk or stem and/or at least sectionally along the first branch, wherein said conduit has at least one outlet, and/or at least sectionally along the second branch, wherein said conduit has at least one outlet, and/or at least sectionally along the third branch, wherein said conduit has at least one outlet, wherein the medium can be directed from the reservoir via one of said conduits to at least one of said outlets, wherein the conduit system comprises at least one valve and preferably multiple valves, in particularly arranged in such a manner to control medium flow into conduits of said branches.

According to a preferred embodiment, the apparatus comprises a pump, wherein the control unit is configured to operate the pump and/or at least one valve in dependency of sensor data of the sensor unit, in particular of the smoke detector or fire sensor.

According to a preferred embodiment, the apparatus comprises a mounting element for mounting the apparatus to a stationary structure, in particular a house or wall or fence or bridge.

According to a preferred embodiment, at least one branch comprises a plurality of solar panels, wherein the plurality of solar panel units are arranged side by side, wherein a first solar panel unit is coupled with a second solar panel unit and wherein the second solar panel unit is coupled with a third solar panel unit and wherein the third solar panel unit is coupled with a fourth solar panel unit, wherein the solar panel units are movable along a guide structure, wherein the solar panels can be arranged in a usage configuration and in a non-usage configuration, wherein an angle between the first solar unit and the second solar unit changes in case the configuration of the apparatus is changed, wherein the angle between the first solar unit and the second solar unit is in the non-usage configuration smaller that 90°, in particularly smaller than 60° or 45°, and wherein the angle between the first solar unit and the second solar unit is in the usage configuration larger than 90°, in particularly larger than 120°, wherein the angle between a first pair of solar units, which are directly coupled to each other, and the angle between a second pair of solar units, which are also directly coupled to each other, changes in case the configuration of the apparatus is changed, wherein the guide structure provides a pivoting mechanism for pivoting at least some of the interconnected solar units along a predefined path.

According to a preferred embodiment, at least one branch comprises a plurality of solar panels, wherein the plurality of solar panel units are arranged side by side, wherein a first solar panel unit is coupled with a second solar panel unit and wherein the second solar panel unit is coupled with a third solar panel unit and wherein the third solar panel unit is coupled with a fourth solar panel unit, wherein the solar panel units are movable along a guide structure, wherein the solar panels can be arranged in a usage configuration and in a non-usage configuration, wherein an angle between the first solar unit and the second solar unit changes in case the configuration of the apparatus is changed, wherein the angle between the first solar unit and the second solar unit is in the non-usage configuration smaller that 90°, in particularly smaller than 60° or 45°, and wherein the angle between the first solar unit and the second solar unit is in the usage configuration larger than 90°, in particularly larger than 120°, wherein the angle between a first pair of solar units, which are directly coupled to each other, and the angle between a second pair of solar units, which are also directly coupled to each other, changes in case the configuration of the apparatus is changed, wherein the guide structure provides a moving or sliding mechanism for moving or sliding at least some of the interconnected solar units along a preferably straight predefined path.

According to a preferred embodiment, at least one branch comprises a plurality of solar panels, wherein the plurality of solar panel units are arranged side by side, wherein a first solar panel unit is coupled with a second solar panel unit and wherein the second solar panel unit is coupled with a third solar panel unit and wherein the third solar panel unit is coupled with a fourth solar panel unit, wherein the solar panel units are movable along a guide structure, wherein the solar panels can be arranged in a usage configuration and in a non-usage configuration, wherein an angle between the first solar unit and the second solar unit changes in case the configuration of the apparatus is changed, wherein the angle between the first solar unit and the second solar unit is in the non-usage configuration smaller that 90°, in particularly smaller than 60° or 45°, and wherein the angle between the first solar unit and the second solar unit is in the usage configuration larger than 90°, in particularly larger than 120°, wherein the angle between a first pair of solar units, which are directly coupled to each other, and the angle between a second pair of solar units, which are also directly coupled to each other, changes in case the configuration of the apparatus is changed, wherein the guide structure provides a moving or sliding mechanism for moving or sliding at least some of the interconnected solar units along a preferably straight predefined path and wherein the guide structure provides a pivoting mechanism for pivoting at least some of the interconnected solar units along a predefined path.

According to a preferred embodiment, the size and/or shape of at least two interconnected solar units and preferably at least three interconnected solar units or at least four interconnected solar units differ from each other.

According to a preferred embodiment, the surface of the smallest solar unit is at least 10% and preferably 20% or 30% or 50% smaller compared to the surface of the largest solar unit.

The present invention is also directed to an awning. The awning preferably comprises at least a mounting element for mounting the awning to a carrying unit, in particularly a house or camper van or mobile home, a plurality of solar panels units, a guide structure for holing the plurality of solar panel units, wherein the plurality of solar panel units are arranged in a row, wherein a first solar panel unit is coupled with a second solar panel unit and wherein the second solar panel unit is coupled with a third solar panel unit and wherein the third solar panel unit is coupled with a fourth solar panel unit, wherein the solar panel units are movable along the guide structure, wherein the solar panels can be arranged in a usage configuration and in a non-usage configuration, wherein an angle between the first solar unit and the second solar unit changes in case the configuration of the awning is changed, wherein the angle between the first solar unit and the second solar unit is in the non-usage configuration smaller than 90°, in particularly smaller than 60° or 45°, and wherein the angle between the first solar unit and the second solar unit is in the usage configuration larger than 90°, in particularly larger than 120°, wherein the angle between a first pair of solar units, which are directly coupled to each other, and the angle between a second pair of solar units, which are also directly coupled to each other, changes in case the configuration of the awning is changed.

Awning according to further preferred embodiment, wherein the guide structure provides a pivoting mechanism for pivoting at least some of the interconnected solar units along a predefined path.

Awning according to further preferred embodiment, wherein the guide structure provides a moving or sliding mechanism for moving or sliding at least some of the interconnected solar units along a preferably straight predefined path.

Awning according to further preferred embodiment, wherein the guide structure provides a moving or sliding mechanism for moving or sliding at least some of the interconnected solar units along a preferably straight predefined path and wherein the guide structure provides a pivoting mechanism for pivoting at least some of the interconnected solar units along a predefined path.

Awning according to further preferred embodiment, wherein the guide structure comprises ropes or cables, wherein the solar units are held by said ropes or cables and wherein the solar units move along at least one rope or cable in case the configuration of the awning is changed.

Awning according to further preferred embodiment, wherein each solar panel unit comprises a solar panel, in particularly a photovoltaic panel, and a carrying member, in particularly a section of a base layer.

Awning according to further preferred embodiment, wherein the size and/or shape of at least two interconnected solar units and preferably at least three interconnected solar units or at least four interconnected solar units differ from each other.

Awning according to further preferred embodiment, wherein the surface of the smallest solar unit is at least 10% and preferably 20% or 30% or 50% smaller compared to the surface of the largest solar unit.

In an embodiment of the invention, a mobile apparatus for converting solar energy to electrical energy comprises a base, a central trunk extending from the base, one or more branches connected to the central trunk, and one or more photovoltaic panels connected to the one or more branches. The photovoltaic panels comprise one or more sheets of photovoltaic material and one or more anchors for attaching the sheets of photovoltaic material to the branches. The branches are configured to be movable with respect to the central trunk.

In another embodiment, the base comprises one or more mobility accessories.

In a further embodiment, the central trunk extends substantially perpendicularly to the base.

In yet a further embodiment, the one or more branches are arranged into a plurality of layers.

In still yet a further embodiment, the branches are pivotably or hingedly connected to the central trunk.

In another embodiment, the central trunk comprises an outer wall, with the outer wall comprising a plurality of wall segments.

In still another embodiment, the wall segments are configured to telescope within one another.

In still yet another embodiment, the mobile apparatus further comprises one or more deployment cables extending between the central trunk and one or more of the branches.

In a further embodiment, the mobile apparatus further comprises a motorized mechanism for moving the branches with respect to the central trunk.

In still a further embodiment, the central trunk further comprises a central reinforcement rod, wherein the central reinforcement rod is configured to be telescoping.

In yet a further embodiment, the sheets of photovoltaic material are substantially flexible.

In still yet another embodiment, the sheets of photovoltaic material are substantially thin.

In another embodiment, the sheets of photovoltaic material are substantially lightweight.

In still another embodiment, the mobile apparatus further comprises one or more sleeves, with each sleeve is configured to hold one or more of the one or more photovoltaic panels.

In a further embodiment, the branches are configured to be foldable such that the photovoltaic panels form one or more bellows.

In still a further embodiment, the mobile apparatus further comprises a security system connected to one or more of the base, central trunk, or branches.

In still another embodiment, the base is substantially hollow.

In yet another embodiment, the mobile apparatus further comprises a weather system, with the weather system affecting the movement of the branches based, at least in part, on the weather.

In still yet a further embodiment, the mobile apparatus further comprises one or more wind turbines for generating electricity from wind power.

In another embodiment, the mobile apparatus further comprises a water sprinkler system.

In still another embodiment, the mobile apparatus further comprises a firefighting system.

In another embodiment, an apparatus for converting solar energy into electrical energy for use with a stationary structure comprises a base attached to the stationary structure, a central stem extending from the base, one or more fronds connected to the central stem, and one or more photovoltaic panels connected to the one or more fronds. The photovoltaic panels comprise one or more sheets of photovoltaic material and one or more anchors for attaching the sheets of photovoltaic material to the fronds. The fronds are configured to be movable with respect to the central stem.

In yet another embodiment, the base extends away from the stationary structure.

In yet another embodiment, the one or more photovoltaic panels are foldable.

In still yet another embodiment, the base is movable with respect to the stationary structure.

In still a further embodiment, the apparatus further comprises structural cables extending between the fronds and the stationary structure.

The foregoing was intended as a summary only and of only some of the aspects of the invention. It was not intended to define the limits or requirements of the invention. Other aspects of the invention will be appreciated by reference to the detailed description of the preferred embodiments. Moreover, this summary should be read as though the claims were incorporated herein for completeness.

### BRIEF DESCRIPTION OF THE DRAWINGS

These and other features of the invention will become more apparent from the following description in which reference is made to the appended drawings and wherein:

FIG. 1 is a view showing the mobile solar tree in accordance with one embodiment of the invention;

FIG. 2 is a view showing an example of the mobile solar tree deployed;

FIG. 3 is another view showing another example of the mobile solar tree deployed;

FIG. 4 is a top view of the mobile solar tree when deployed;

FIG. 5 is a view showing the mobile solar tree extended;

FIG. 6 is a partial view showing the mobile solar tree extended;

FIG. 7 shows partial views of the mobile solar tree in its extended and retracted configurations;

FIG. 8 is another partial view showing the mobile solar tree extended;

FIG. 9 is a top view showing the solar tree;

FIG. 10 is a view showing the mobile solar vessel in accordance with another embodiment of the invention;

FIG. 11 is a view showing an example of the mobile solar vessel deployed;

FIG. 12 is another view showing another example of the mobile solar vessel deployed;

FIG. 13 is a top view of the mobile solar vessel when deployed;

FIG. 14 is a view showing the mobile solar vessel extended;

FIG. 15 is a partial view showing the mobile solar vessel extended;

FIG. 16 shows partial views of the mobile solar vessel in its extended and retracted configurations;

FIG. 17 is another partial view showing the mobile solar vessel extended;

FIG. 18a is a top view showing the mobile solar vessel;

FIG. 18b shows various embodiments of the dynamic building-integrated photovoltaics (DBIPV) structure in accordance with various embodiments of the invention;

FIG. 19 is a view showing one embodiment of the DBIPV structure in accordance with another embodiment of the invention;

FIGS. 20 to 25 are views showing further examples of the DBIPV structure;

FIGS. 26 to 28 are views showing embodiments of the DBIPV structure;

FIG. 29 is a perspective view of an embodiment of the sleeve for the PV panels;

FIG. 30 shows an embodiment of the floating solar clouds;

FIGS. 31a and 31b show embodiments of the floating solar clouds in a vertical configuration;

FIG. 32 shows an embodiment of the floating solar clouds in a horizontal configuration, and the multilayer embodiment;

FIGS. 33a and 33b show embodiments of the dynamic building-integrated photovoltaics bellows (DBIPVB);

FIGS. 34a, 34b, and 34c show embodiments of the DBIPVB in the open configuration;

FIGS. 35a and 35b show embodiments of the DBIPVB with Z-Arch channels;

FIGS. 36a and 36b show embodiments of the DBIPVB with a lamppost;

FIGS. 37a and 37b show embodiments of the DBIPVB in the open configuration;

FIGS. 38a and 38b show other embodiments of the DBIPVB;

FIG. 39 shows another embodiment of the DBIPVB with Z-Arch channels;

FIG. 40 shows the opening and closing of the DBIPVB with Z-Arch channels;

FIGS. 41a and 41b show magnified views of the DBIPVB with Z-Arch channels;

FIG. 42a shows another embodiment of the DBIPVB with Z-Arch channels;

FIG. 42b shows a magnified view of how two Z-Arch channels engage into each other for closing of the embodiment of FIG. 42a;

FIGS. 43a and 43b show an embodiment of the solar tree bellows, without and with the PV panels, respectively;

FIGS. 44a and 44b show a top view of the solar tree bellows, without and with the PV panels, respectively;

FIGS. 45a and 45b show another embodiment of the solar tree bellows, with and without the PV panels, respectively in the semi-closed position;

FIGS. 46a, 46b, FIGS. 46c, 46d, and 46e show an arrangement of solar tree bellows, in open and semi-closed and closed configurations;

FIGS. 47a, 47b, and 47c show another arrangement of the solar tree bellows, in various configurations, respectively;

FIGS. 48 to 50 show the opening and closing of various embodiments of the DBIPVB and the solar tree bellows; and

FIG. 51 shows an embodiment of the floating solar cloud.

### DETAILED DESCRIPTION OF THE INVENTION

The following detailed description should be read with reference to the drawings. The drawings, which are not to scale, depict illustrative embodiments and are not intended to limit the scope of the invention.

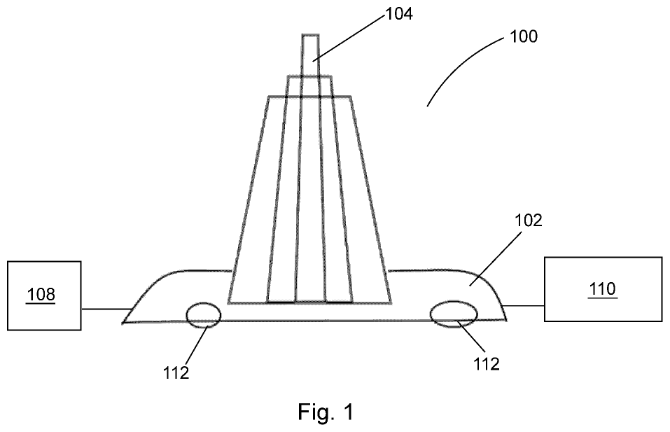

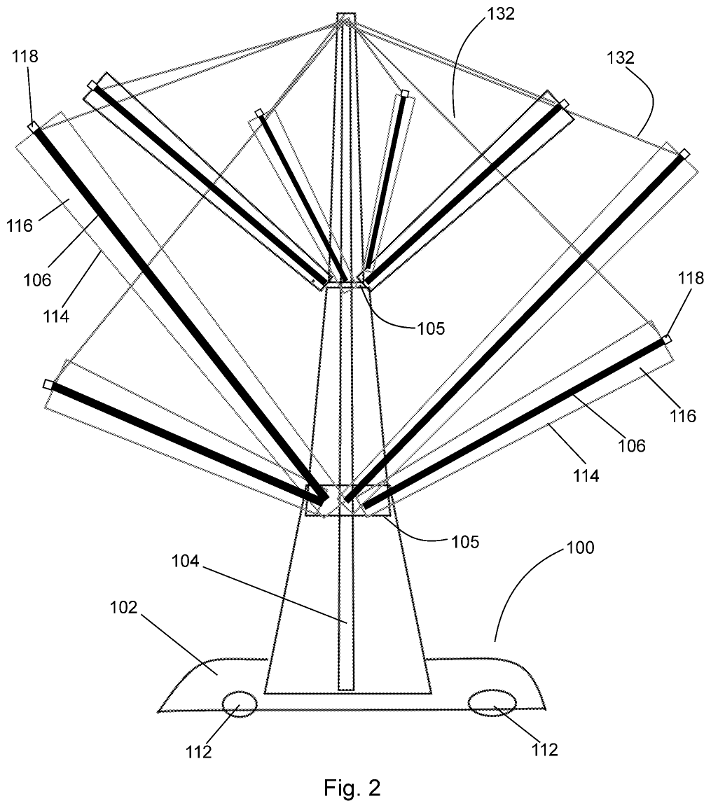

Referring to FIGS. 1 to 9, in accordance with one embodiment of the invention, a mobile solar tree 100 comprises a solar tree base 102 and a solar tree trunk 104 extending from the solar tree base 102. In one embodiment, the solar tree trunk 104 may extend substantially perpendicularly from the solar tree base 102. One or more solar tree branches 106 are connected to the solar tree trunk 104. Preferably, the solar tree branches 106 are hingedly or pivotably connected to the solar tree trunk 104 such that they may be actuated with respect to the solar tree trunk 104. In the embodiment shown in FIGS. 1 to 3, the solar tree trunk 104 comprises one or more horizontal bars 105 for attachment of the solar tree branches 106. For example, the solar tree branches 106 may be actuated mechanically, hydraulically, or electrically. In addition, the actuation may be manual or automatic. In one embodiment, the solar tree branches 106 may be actuated in a similar manner to that of the opening and closing of awnings.

The mobile solar tree 100 may be removably fixed in place, with the advantage of being easily demounted and moved to other locations as necessary.

One or more of the solar tree base 102, the solar tree trunk 104, or the solar tree branches 106 may be connected to a security system 108 to deter theft or vandalism or for other purposes. The security system 108 may be part of the mobile solar tree 100 or it may be separate from it. Moreover, the mobile solar tree 100 may house or be attached to a charging system 110. The charging system 110 may be used to provide electrical power that is generated by the mobile solar tree 100 to charge a battery or to charge an electric vehicle or any other item.

The solar tree base 102 may be shaped in any number of forms but preferably is shaped like the base of a conventional tree. For example, in the embodiment shown in FIGS. 1 to 3, the solar tree base 102 has a substantially elongated shape. It may be formed from lightweight or composite plastic or metal. Preferably, the solar tree base 102 is substantially hollow, allowing it to be filled with a suitable ballast (such as water) that may be drained out when required to dismantle the mobile solar tree 100 for deployment to another location.

It may also be possible to fit the bottom of the solar tree base 102 with one or more mobility accessories 112 for allowing the mobile solar tree 100 to be more easily moved or transported from one location to another. The mobility accessories 112 may include wheels, casters, or the like. For example, in the embodiment shown in FIGS. 1 to 3, the solar tree base 102 is fitted with pairs of wheels as the mobility accessories 112. The mobility accessories 112 may be motorized. In addition, they may also be configured to be recessed or hidden within the solar tree base 102 when not in use for ease of transport or for aesthetic purposes. This may be especially the case where the mobile solar tree 100 is expected to be moved over short distances, as this avoids the need to have to close or dismantle the mobile solar tree 100 each time. Furthermore, the solar tree base 102 may also incorporate seating, especially when deployed in public parks and places.

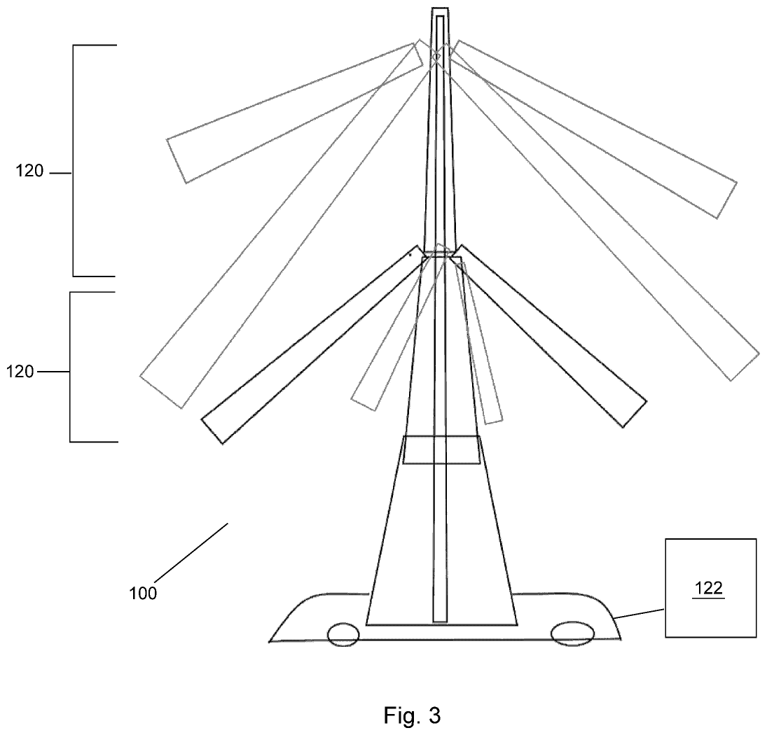

The mobile solar tree 100 further comprises one or more photovoltaic (PV) panels 114 that are attached to the solar tree branches 106. The PV panels 114 are able to convert solar energy into electricity. The PV panels 114 comprise one or more sheets 116 of photovoltaic material and one or more anchors 118. The sheets 116 may be stretched, with the sheets 116 connected to the anchors 118, preferably proximate to the edges of the sheets 116. The anchors 118 are configured to be attached to the solar tree branches 106. In one embodiment, the PV panels 114 may be arranged to form one or more layers 120 of horizontally- or vertically-extended PV panels 114 to simulate the fronds or branches of a tree. For example, in the embodiment shown in FIG. 3, there are two layers 120 of PV panels 114 (one above another).

Preferably, the PV panels 114 are arranged in such a fashion so as to avoid them overlapping with each other as much as possible to allow the solar rays and light to filter through each layer 120 while trying to avoid casting shade on each other as much as possible, in order to maximize the efficiency of the PV panels 114 (see, for example, FIGS. 4 and 5). In one embodiment, the sheets 116 of photovoltaic material are substantially transparent. In this embodiment, the PV panels 114 may be arranged in an overlapping manner since the overlapping does not affect the penetration of the solar rays and efficiency of the PV panels 114.

In another embodiment, the PV panels 114 may be inserted or sandwiched within or sandwiched between layers of a material or fabric, with the upper layer of the material or fabric being substantially transparent to allow sunlight through. This embodiment would also help in replacing the PV panels 114 whenever they need to be replaced due to damage or failure. Each of the sandwiched PV panels 114 could constitute a mobile solar cloud and they may be interconnected in a variety of methods, as described later. Those units could also be manufactured to be sold as individual PV panels kits ready to be connected together as desired.

The mechanisms for opening, deploying, extending, or closing the PV panels 114 are preferably housed in one or both of the solar tree trunk 104 or the solar tree branches 106. These may be mechanically or hydraulically operated, or electrically motorized and controlled by an electronic system and program, which may be reprogrammed and updated as required, with various degrees of automation. For example, the mobile solar tree 100 may be connected (wiredly or wirelessly) to a weather system 122 whereby the mobile solar tree 100 would be caused to close if the weather becomes (or is forecast to be) inclement. The mobile solar tree 100 may also be linked (wiredly or wirelessly) with one or more other mobile solar trees 100 so that all of them open and close when required, such as in emergencies or when multiple mobile solar trees 100 are being deployed in a park, an area, a building, or any other structure. The mobile solar trees 100 arranged in this manner may be used to form an actual solar “park” without having to remove plants or dig up the grounds.

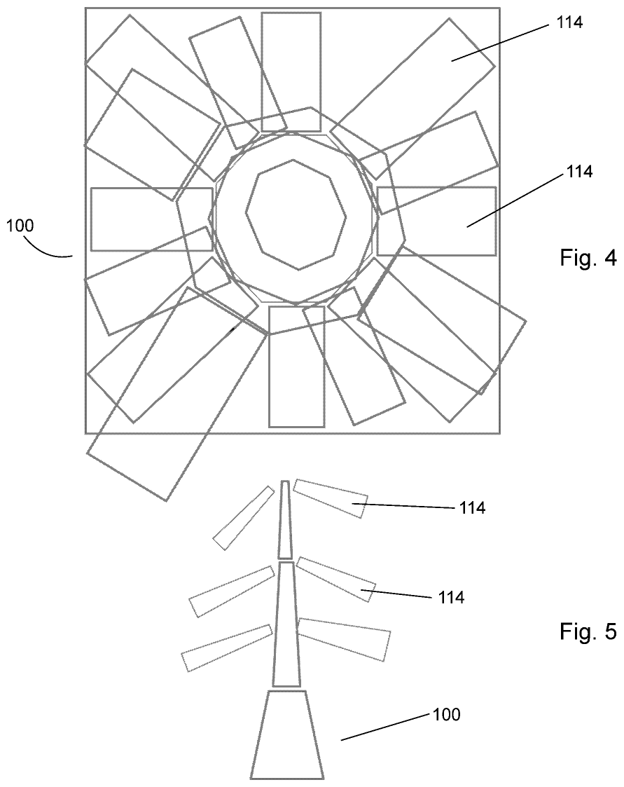

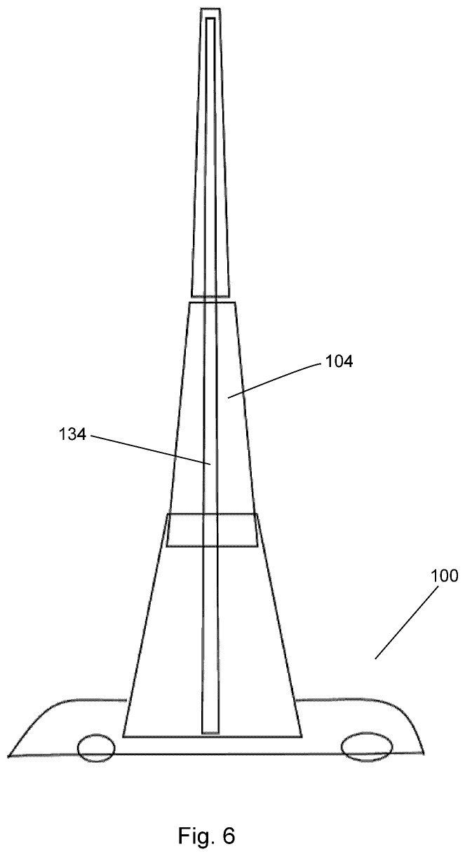

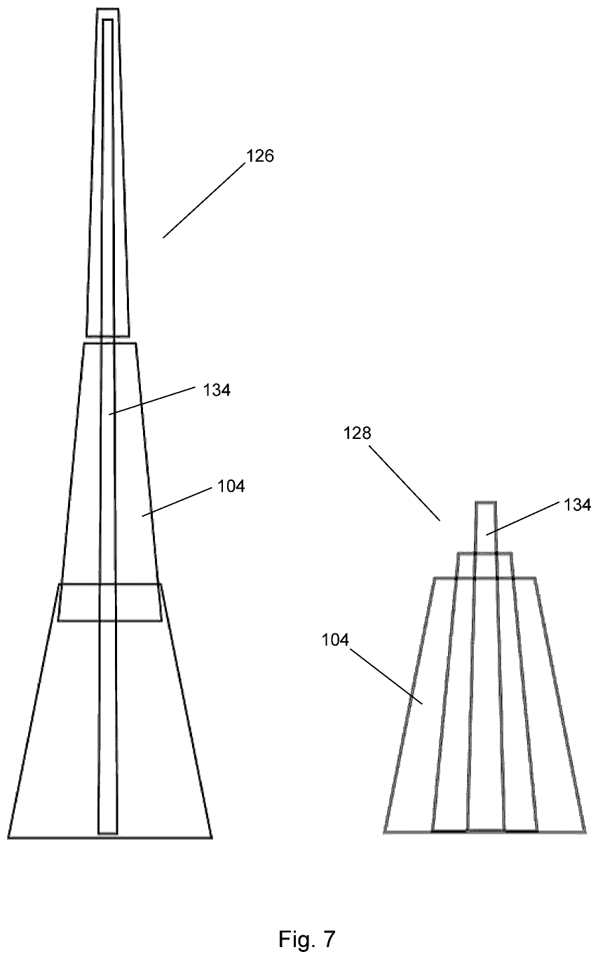

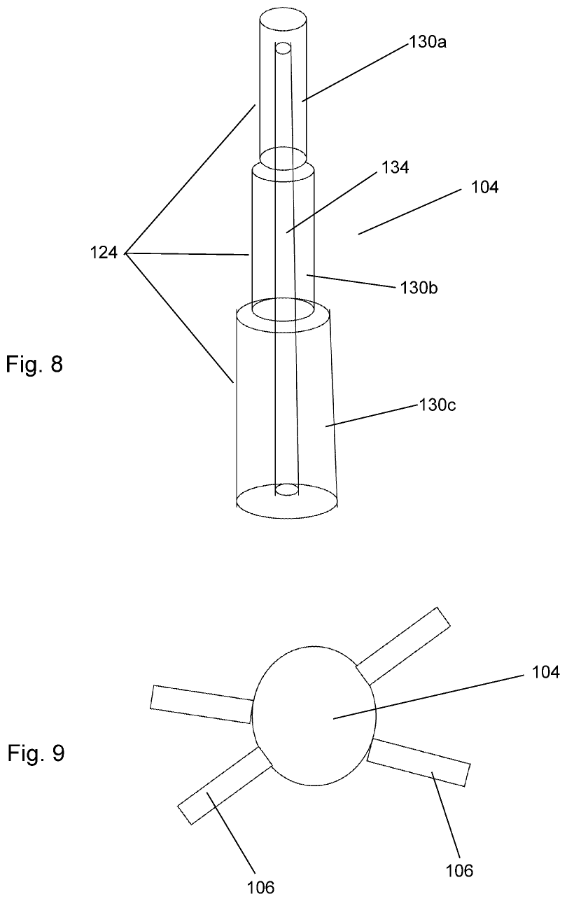

The solar tree trunk 104 may be substantially hollow to allow it to house the solar tree branches 106 within it. The solar tree trunk 104 comprises an outer wall 124 that may be telescoping, such that the overall height of the solar tree trunk 104 may be greatly reduced when the outer wall 124 is collapsed together. Preferably, the outer wall 124 is constructed from a strong lightweight plastic, metal, or composite material. Referring to FIGS. 6 and 7, the solar tree trunk 104 may have an extended (or open) configuration 126 and a retracted (or closed) configuration 128. Because of the telescoping nature of the outer wall 124, portions of the solar tree trunk 104 may extend from inside one another during the transition from the retracted configuration 128 to the extended configuration 126. For example, referring to FIGS. 8 and 9, the outer wall 124 may be broken up into a plurality of wall segments 130a, 130b, 130c, wherein a higher wall segment 130a may telescope into lower wall segment 130b, 130c when transitioning from the extended configuration 126 to the retracted configuration 128. Preferably, there is a mechanism to lock the wall segments 130 in place when the wall segments 130 are fully extended from each other and a mechanism to unlock the wall segments 130 in order to begin the process of collapsing the wall segments 130. The number and size of the wall segments 130a, 130b, 130c would depend on the overall size and height required of the mobile solar tree 100.

Alternatively, in another embodiment, instead of the wall segments 130 telescoping into one another, the wall segments 130 may be removably detached from each other. The wall segments 130 may still be of different sizes.

The solar tree branches 106 are preferably attached to the PV panels 114 in such a manner as to allow for the manipulation and movement of the PV panels 114. The solar tree branches 106 may be mechanically operated or electrically motorized and controlled as described above.

In another embodiment, the mobile solar tree 100 may also comprise one or more deployment cables 132 connected to the solar tree trunk 104 and to solar tree branches 106. The deployment cables 132 may be used to assist in deploying the solar tree branches 106. For example, the deployment cables 132 may extend or retract from the solar tree trunk 104, thereby causing the solar tree branches 106 to pivot away from or pivot toward, respectively, the solar tree trunk 104.

The solar tree branches 106 may be configured to deploy the PV panels 114 to open horizontally or vertically (and various degrees in between), and the solar tree branches 106 may open in layers 120, spaced as necessary to allow for the sun to reach the PV panels 114. There are many possible mechanisms for opening and closing the PV panels 114. There are also many shapes and designs possible for the solar tree branches 106 and the PV panels 114. For example, preferably, the PV panels 114 situated lower on the solar tree trunk 104 extend further away from the solar tree trunk 104 to avoid being shadowed by the PV panels 114 located above them. In the case where the sheets 116 of the PV panels 114 are substantially transparent or translucent, this is generally less important as the light is able to filter down through the sheets 116 without affecting the performance of the PV panels 114 underneath, and more layers 120 of PV panels 114 may be used in a denser configuration. It is also possible to use a combination of transparent and less transparent PV panels 114 when and as required to provide better performance.

The height of the mobile solar tree 100 may be increased or decreased as required and the design could vary upon the taste. The size and number of the solar tree branches 106 would generally be the main factor in deciding the amount of energy produced.

Depending on the overall height of the mobile solar tree 100, the solar tree trunk 104 may also comprise a central reinforcement rod 134 to provide additional strength and support. The reinforcement rod 134 may also be telescoping to reduce its overall height when transitioning from the extended configuration 126 to the retracted configuration 128.

By way of example only, using the CIGS—(Cadmium Indium Gallium Selenium) type of thin and light and flexible photovoltaic cells for the sheets 116, a mobile solar tree 100 that is approximately three meters high may have three layers 120 of PV panels 114, with a one-meter spacing between each layer 120 to allow as much light to pass through to the PV panels 114. Each layer 120 may have eight solar tree branches 106, if, for example, the solar tree trunk 104 has a generally octagonal cross-section as shown in FIG. 4 (or even a round cross-section with octagonal spacing). The solar tree branches 106 may vary in width and length, and in order to allow more light to reach the PV panels 114 of the solar tree branches 106 below, the PV panels 114 may be staggered so that there is a space and gap from one layer 120 over the other. Therefore, one possible configuration could be as follows:

The PV panels 114 in the upper layer 120 may be 0.5 meters wide by 1.5 meters long, thus creating a surface area of 0.75 square meters, with eight PV panels 114 totaling 6 square meters.

The PV panels 114 in the middle layer 120 may be 0.75 meters wide by 2 meters long, thus creating a surface area of 1.5 square meters, with eight PV panels 114 totaling 12 square meters.

The PV panels 114 in the lower layer 120 may be 1 meter wide by 2 meters long, thus creating a surface area of 2 square meters, with eight PV panels 114 totaling 16 square meters.

The total surface area of the PV panels 114 for the three layers 120 would be 34 square meters. At an average, PV panels 114 comprising flexible sheets 116 of photovoltaic material may typically produce 120 watt/square meter. Therefore, the mobile solar tree 100 would produce approximately 120 watt/m²×34 m²=4,080 watts, which could power an average three-bedroom house with possibly a window air conditioner or even more, depending on the geographic location and if the sun shines all the time. The output would be even higher when using mono- or poly-silicon fiberglass-based thin and light and flexible panels.

Such a mobile solar tree 100 would have 34 square meters area of PV panels 114 while it would occupy a footprint of only 16 square meters (4 meters×4 meters) in plan and would use only 4 square meters of floor area with a base of 2 meters×2 meters. This could constitute a saving of over 82.3% of land in comparison to the traditional ground-mounted PV panel systems, which would occupy more than 16 square meters, with a PV area of only 16 square meters to allow for distances between panels.

It is important to point out that mobile solar trees 100 with organic photovoltaic (OPV) and other transparent PV material could be able to produce higher yields due to the ability of stacking more PV panels 114 in multiple layers.

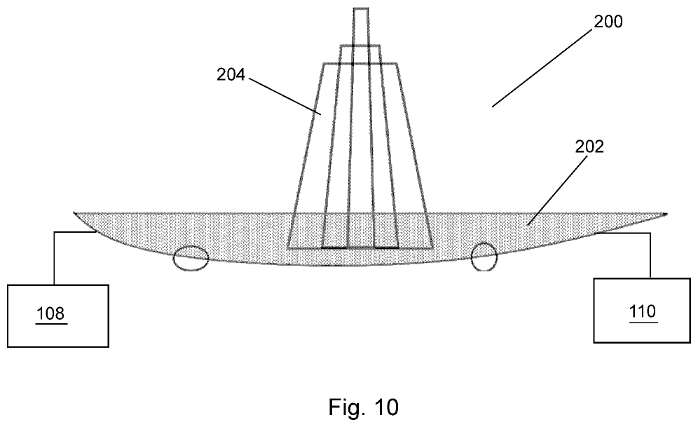

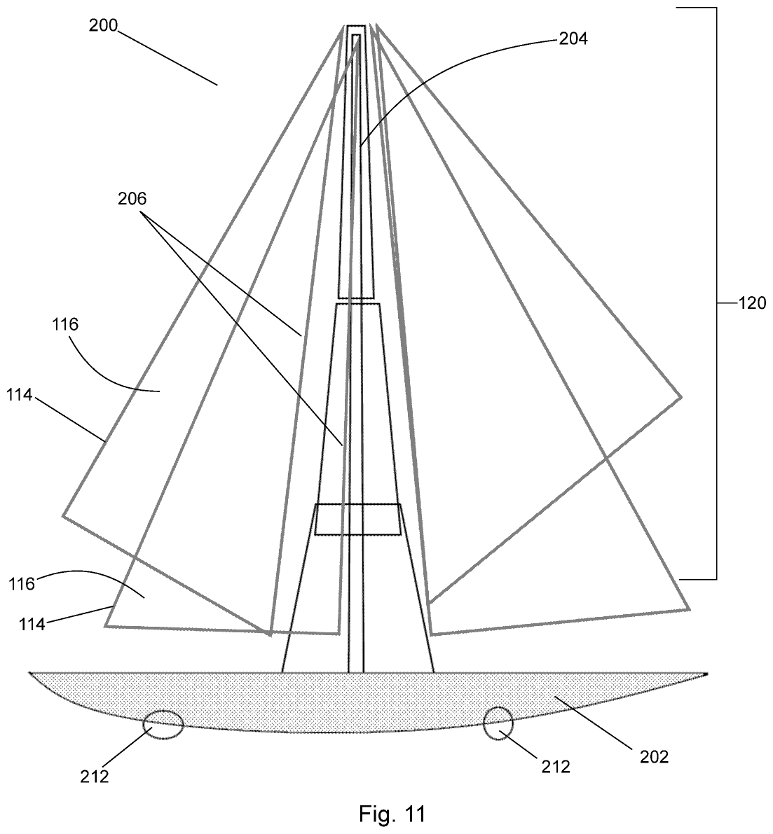

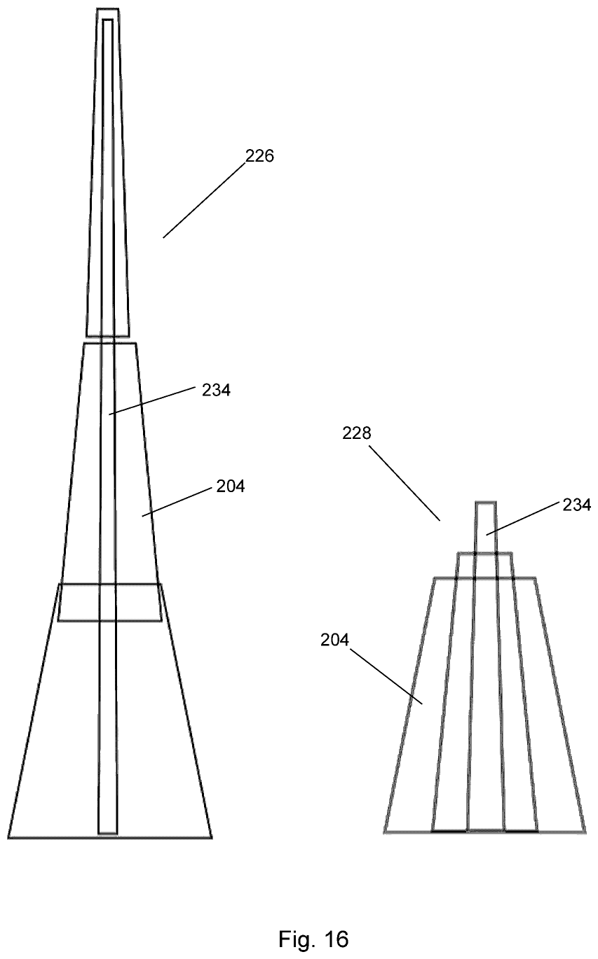

Referring to FIGS. 10 to 18, in another embodiment of the invention, a mobile solar vessel 200 comprises a solar vessel base 202 and a solar vessel mast 204 extending from the solar vessel base 202. In one embodiment, the solar vessel mast 204 may extend substantially perpendicularly from the mobile solar vessel 200. One or more solar vessel sails 206 are connected to the solar vessel mast 204. Preferably, the solar vessel sails 206 are hingedly or pivotably connected to the solar vessel mast 204 such that they may be actuated with respect to the solar vessel mast 204. For example, the solar vessel sails 206 may be actuated mechanically, hydraulically, or electrically. In addition, the actuation may be manual or automatic. In one embodiment, the solar vessel sails 206 may be actuated in a similar manner to that of the opening and closing of awnings.

The mobile solar vessel 200 may be removably fixed in place, with the advantage of being easily demounted and moved to other locations as necessary.

One or more of the solar vessel base 202, the solar vessel mast 204, or the solar vessel sails 206 may be connected to security system 108 to deter theft or vandalism or for other purposes. The security system 108 may be part of the mobile solar vessel 200 or it may be separate from it. Moreover, the mobile solar vessel 200 may house or be attached to charging system 110. The charging system 110 may be used to provide electrical power that is generated by the mobile solar vessel 200 to charge a battery or to charge an electric vehicle or any other item.

The solar vessel base 202 may be shaped in any number of forms but preferably is shaped like the base of a conventional boat hull. For example, in the embodiment shown in FIGS. 10 to 12, the solar vessel base 202 has a substantially elongated shape. It may be formed from lightweight or composite plastic or metal. Preferably, the solar vessel base 202 is substantially hollow, allowing it to be filled with a suitable ballast (such as water) that may be drained out when required to dismantle the mobile solar vessel 200 for deployment to another location.

It may also be possible to fit the bottom of the solar vessel base 202 with one or more vessel mobility accessories 212 for allowing the mobile solar vessel 200 to be more easily moved or transported from one location to another. The vessel mobility accessories 212 may include wheels, casters, or the like. For example, in the embodiment shown in FIGS. 10 to 12, the solar vessel base 202 is fitted with pairs of wheels as the vessel mobility accessories 212. The vessel mobility accessories 212 may be motorized. In addition, they may also be configured to be recessed or hidden within the solar vessel base 202 when not in use for ease of transport or for aesthetic purposes. This may be especially the case where the mobile solar vessel 200 is expected to be moved over short distances, as this avoids the need to have to close or dismantle the mobile solar vessel 200 each time. Furthermore, the solar vessel base 202 may also incorporate seating, especially when deployed in public parks and places.

The mobile solar vessel 200 further comprises one or more PV panels 114 that are attached to the solar vessel sails 206. The anchors 118 on the PV panels 114 are configured to be attached to the solar vessel sails 206. In one embodiment, the PV panels 114 may be arranged to form one or more layers 120 of horizontally- or vertically-extended PV panels 114 to simulate the sails of a boat (not shown).

Preferably, as with the mobile solar tree 100, the PV panels 114 for the mobile solar vessel 200 are arranged in such a fashion so as to avoid them overlapping with each other as much as possible to allow the solar rays and light to filter through while trying to avoid casting shade on each other as much as possible, in order to maximize the efficiency of the PV panels 114. In one embodiment, the sheets 116 of photovoltaic material are substantially transparent. In this embodiment, the PV panels 114 may be arranged in an overlapping manner since the overlapping does not affect the penetration of the solar rays and efficiency of the PV panels 114.

The mechanisms for opening, deploying, extending, or closing the PV panels 114 are preferably housed in one or both of the solar vessel mast 204 or the solar vessel sails 206. These may be mechanically or hydraulically operated, or electrically motorized and controlled by an electronic system and program, which may be reprogrammed and updated as required, with various degrees of automation. For example, the mobile solar vessel 200 may be connected (wiredly or wirelessly) to weather system 122 whereby the mobile solar vessel 200 would be caused to close if the weather becomes (or is forecast to be) inclement. The mobile solar vessel 200 may also be linked (wiredly or wirelessly) with one or more other mobile solar vessels 200 or one or more mobile solar trees 100 so that all of them open and close when required, such as in emergencies or when multiple mobile solar vessels 200 and/or mobile solar trees 100 are being deployed in a park, an area, a building, or any other structure. The mobile solar vessels 200 and mobile solar trees 100 arranged in this manner may be used to form a virtual solar “park” without having to remove plants or dig up the grounds.

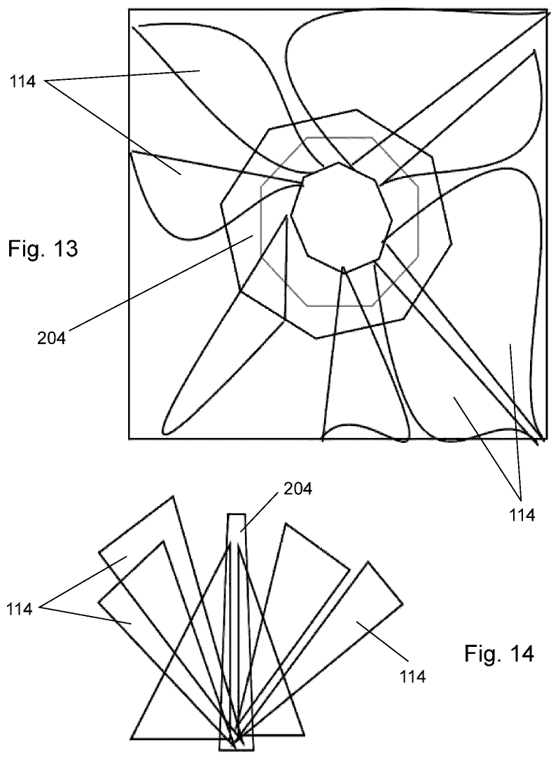

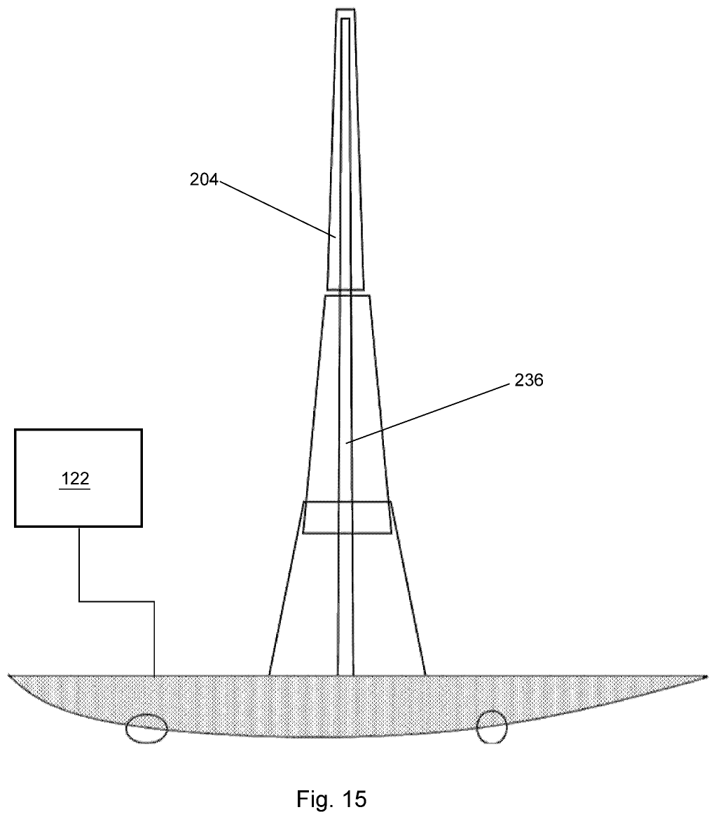

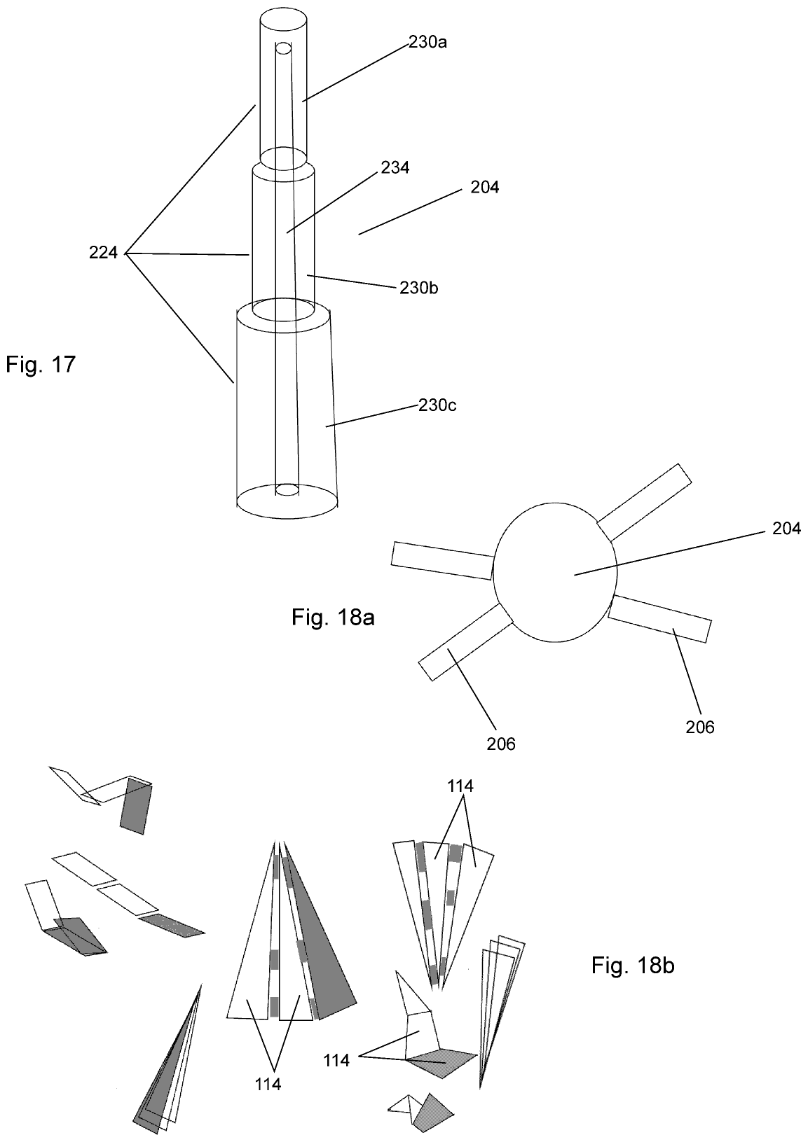

The solar vessel mast 204 may be substantially hollow to allow it to house the solar vessel sails 206 within it. The solar vessel mast 204 comprises a vessel outer wall 224 that may be telescoping, such that the overall height of the solar vessel mast 204 may be greatly reduced when the vessel outer wall 224 is collapsed together. Preferably, the vessel outer wall 224 is constructed from a strong lightweight plastic, metal, or composite material. Referring to FIGS. 15 to 17, the solar vessel mast 204 may have an extended (or open) vessel configuration 226 and a retracted (or closed) vessel configuration 228. Because of the telescoping nature of the vessel outer wall 224, portions of the solar vessel mast 204 may extend from inside one another during the transition from the retracted vessel configuration 228 to the extended vessel configuration 226. For example, the vessel outer wall 224 may be broken up into a plurality of vessel wall segments 230, wherein a higher vessel wall segment 230 may telescope into a lower vessel wall segment 230 when transitioning from the extended vessel configuration 226 to the retracted vessel configuration 228. For example, referring to FIGS. 17 and 18, the outer wall 224 may be broken up into a plurality of wall segments 230a, 230b, 230c, wherein a higher wall segment 230a may telescope into lower wall segment 230b, 230c when transitioning from the extended configuration 226 to the retracted configuration 228. Preferably, there is a mechanism to lock the vessel wall segments 230 in place when the vessel wall segments 230 are fully extended from each other and a mechanism to unlock the vessel wall segments 230 in order to begin the process of collapsing the vessel wall segments 230. The number and size of the vessel wall segments 230 would depend on the overall size and height required of the mobile solar vessel 200.

Alternatively, in another embodiment, instead of the vessel wall segments 230 telescoping into one another, the vessel wall segments 230 may be removably detached from each other. The vessel wall segments 230 may still be of different sizes.

Depending on the overall height of the mobile solar vessel 200, the solar vessel mast 204 may also comprise a central vessel reinforcement rod 234 to provide additional strength and support. The vessel reinforcement rod 234 may also be telescoping to reduce its overall height when transitioning from the extended configuration 226 to the retracted configuration 228.

The solar vessel sails 206 are preferably attached to the PV panels 114 in such a manner as to allow for the manipulation and movement of the PV panels 114. The solar vessel sails 206 may be mechanically operated or electrically motorized and controlled as described above.

In another embodiment, the mobile solar vessel 200 may also comprise one or more vessel deployment cables 232 connected to the solar vessel mast 204 and to solar vessel sails 206. The vessel deployment cables 232 may be used to assist in deploying the solar vessel sails 206. For example, the vessel deployment cables 232 may extend or retract from the solar vessel mast 204, thereby causing the solar vessel sails 206 to pivot away from or pivot toward, respectively, the solar vessel mast 204.

The solar vessel sails 206 may be configured to deploy the PV panels 114 to open horizontally or vertically (and various degrees in between), and the solar vessel sails 206 may open in layers 120, spaced as necessary to allow for the sun to reach the PV panels 114. There are many possible mechanisms for opening and closing the PV panels 114, and some examples are shown in FIG. 18b. There are also many shapes and designs possible for the solar vessel sails 206 and the PV panels 114, as shown in FIG. 18b. For example, preferably, the PV panels 114 situated lower on the solar vessel mast 204 extend further away from the solar vessel mast 204 to avoid being shadowed by the PV panels 114 located above them. In the case where the sheets 116 of the PV panels 114 are substantially transparent or translucent, this is generally less important as the light is able to filter down through the sheets 116 without affecting the performance of the PV panels 114 underneath, and more layers 120 of PV panels 114 may be used in a denser configuration. It is also possible to use a combination of transparent and less transparent PV panels 114 when and as required to provide better performance.

The height of the mobile solar vessel 200 may be increased or decreased as required and the design could vary upon the taste. The size and number of the solar vessel sails 206 would generally be the main factor in deciding the amount of energy produced.

By way of example only, using the CIGS-type of thin and light and flexible photovoltaic cells for the sheets 116, a mobile solar vessel 200 that is approximately three meters high may have multiple layers 120 of PV panels 114, with a 0.5-meter spacing between each layer 120 to allow as much light to pass through to the PV panels 114. Each layer 120 may have eight solar vessel sails 206, if, for example, the solar vessel mast 204 has a generally octagonal cross-section (or even a round cross-section with octagonal spacing). For example, the PV panels 114 for the mobile solar vessel 200 may be generally triangular in shape.

In one configuration, each of the PV panels 114 may have a base length of 3 meters wide by 3 meters high, thus creating a surface area of 4.5 square meters per PV panel 114. With 8 PC panels 114, there would be a total surface area of 36 square meters. However, if the PV panels 114 were spaced closer together, the number of PV panels 114 may be doubled (i.e. to 16), with the total surface area then being 72 square meters.

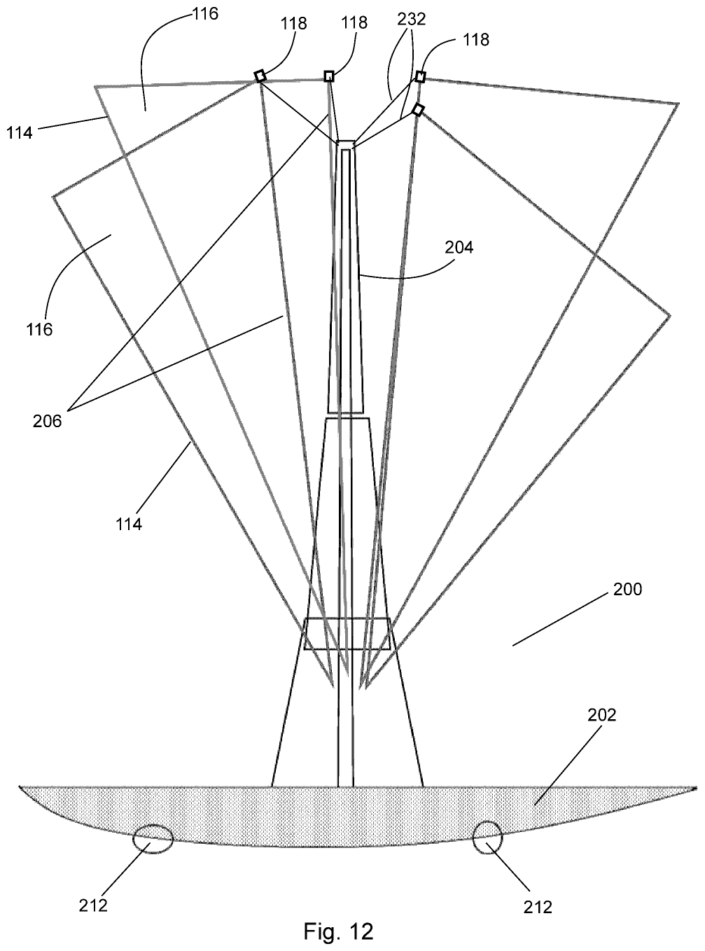

There are other possible embodiments of the mobile solar vessel 200 and how the solar vessel masts 204 fan out. For example, the PV panels 114 may be arranged in an “upside-down” orientation (as shown in FIG. 12), with the wide base being at the top. This would allow the PV panels 114 to fan out more. This would also allow the PV panels 114 to be farther away from one another at the top where the area is larger, and this would enable them to absorb more light, especially during the parts of the day with the highest illumination. This configuration allows for a smaller footprint area on the ground while taking up more space at higher levels.

It is also possible to use a combination of different configurations of the PV panels 114 as a head-to-toe design and other designs when required to deploy as much surface area of PV panels 114 as possible.

The total surface area of the PV panels 114 attached to the solar vessel sails 206 may be 36 square meters. At an average, PV panels 114 comprising flexible sheets 116 of photovoltaic material may typically produce 120 watt/square meter. Therefore, the mobile solar vessel 200 could generate about 120 watt/m²×36 m²=4,320 watts, which could power an average three-bedroom house with possibly a window air conditioner or even more depending on the geographic location and if the sun shines all the time.

In the case where the surface area of the PV panels 114 is 72 square meters, the power generated would be approximately 120 watt/m²×72 m²=8,640 watts, which could power an even larger (perhaps a six-bedroom) house with possibly a window air conditioner or even more depending on the geographic location and if the sun shines all the time.

The solar vessel sails 206 may carry between 36 to 72 square meters of surface area of PV panels 114, while they would occupy a footprint space area of only 36 square meters (6 m×6 m) in plan and would use only 6 square meters of floor area with an assumed base of 2 m×3 m. This constitutes a saving of over 82.3% of land in comparison to the traditional ground-mounted PV panel systems.

It is important to point out that mobile solar vessels 200 with OPV and other transparent PV material could be able to produce higher yields due to the ability of stacking more PV panels 114 in multiple layers, and some are able to provide almost similar output per PV panel 114 as the CIGS used for the calculations above and may even eventually exceed it. With new PV materials emerging, even more energy output and options are possible.

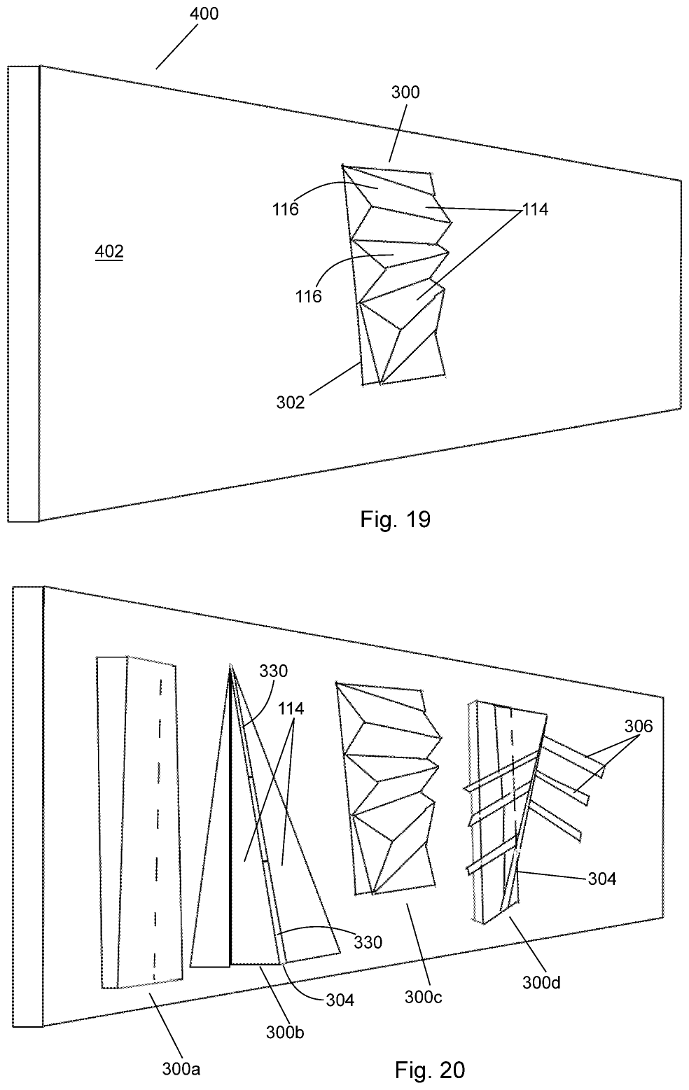

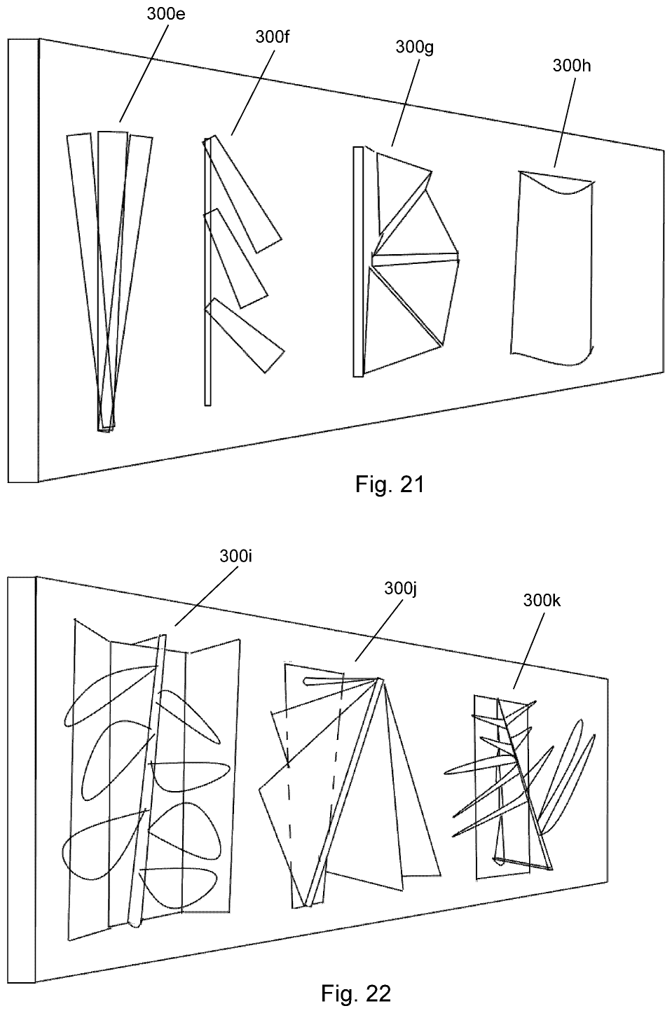

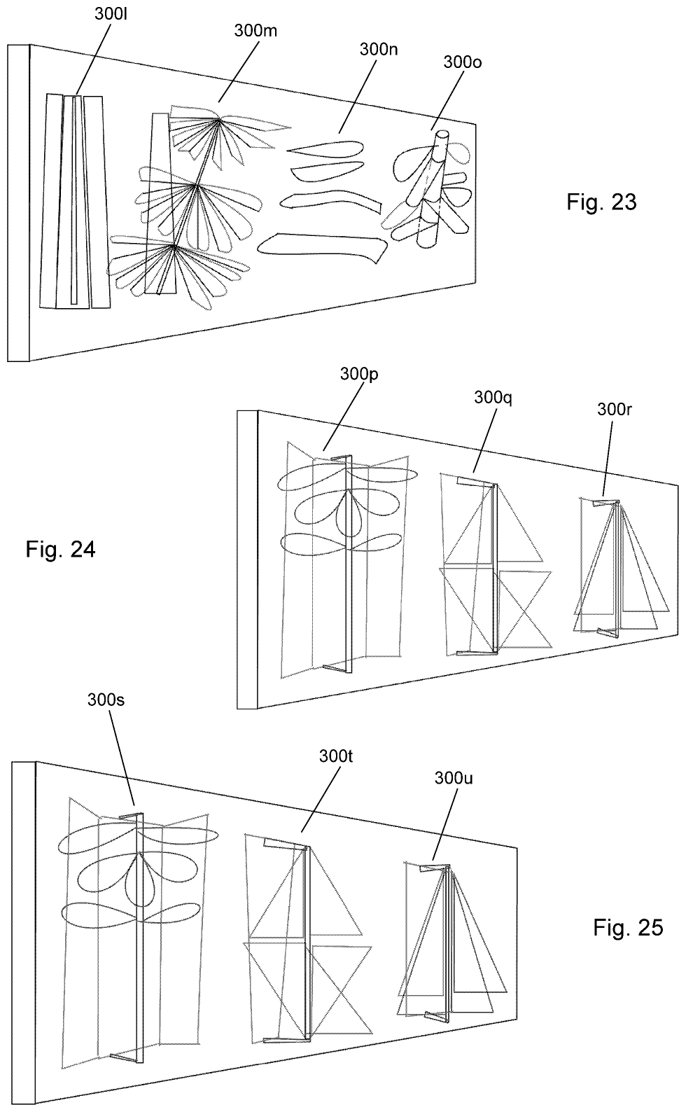

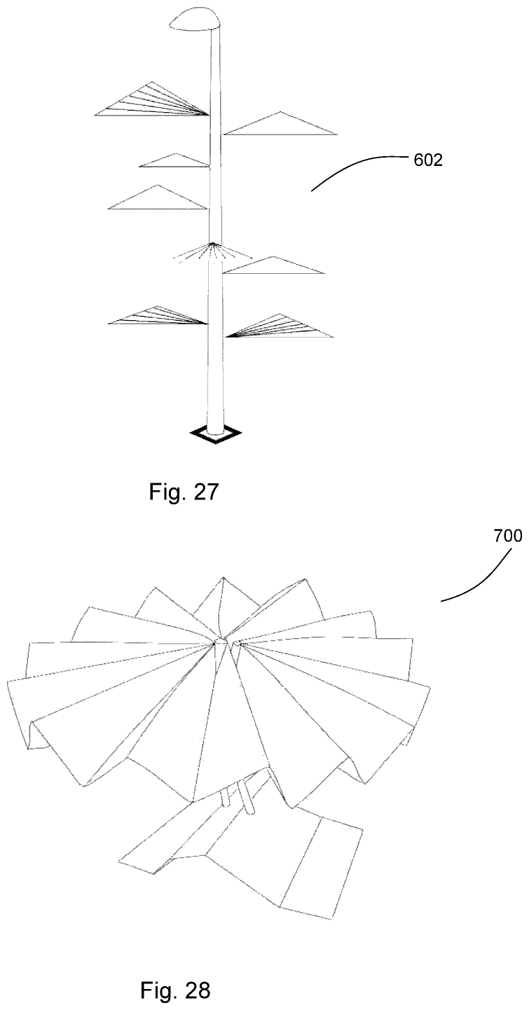

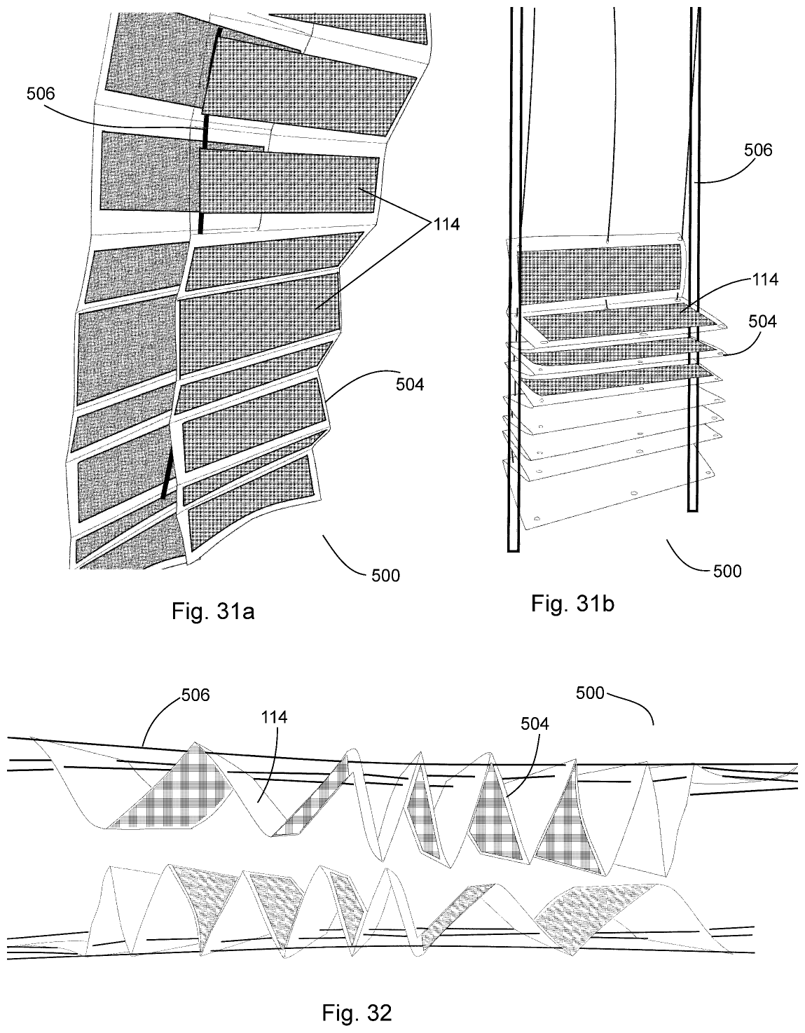

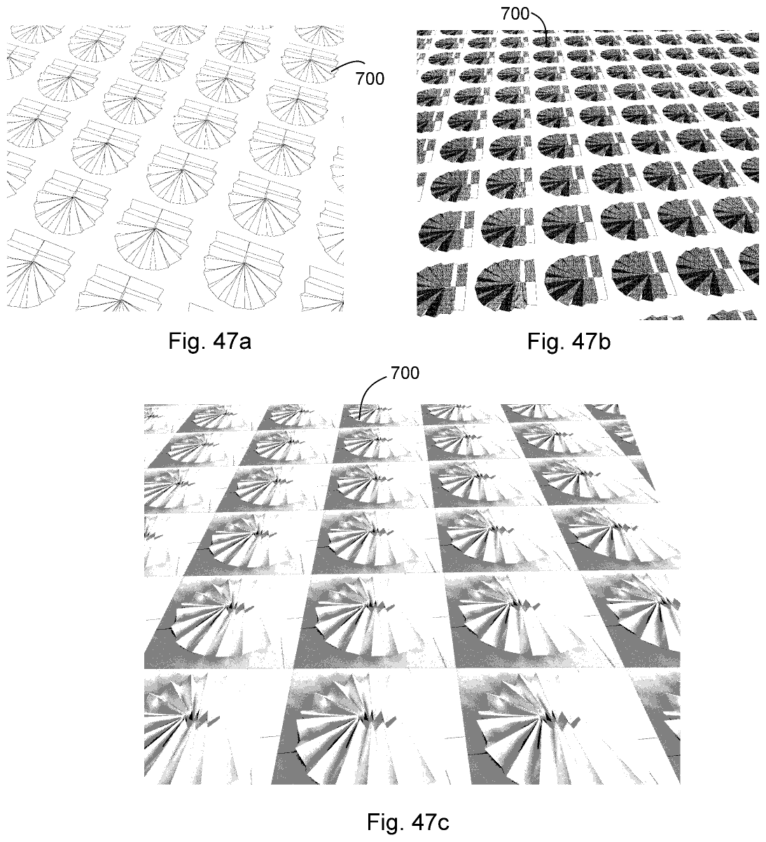

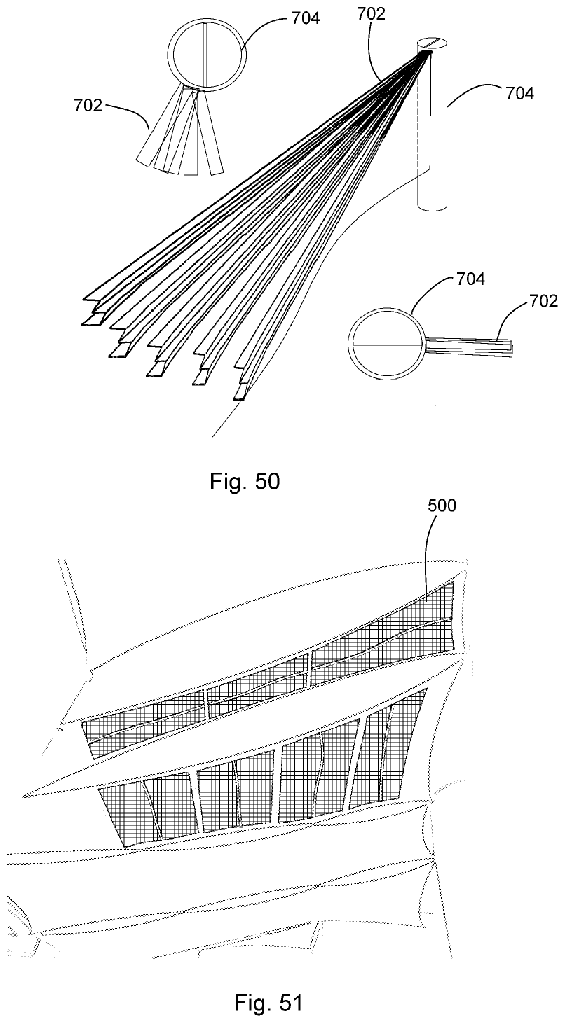

Referring to FIGS. 19 to 51, in another embodiment of the invention, a dynamic building-integrated photovoltaic (DBIPV) structure 300 incorporates portions of the mobile solar tree 100 and the mobile solar vessel 200. The DBIPV structure 300 is configured to be embedded or attached to a structure 400 (such as a building) and is configured to open and close when desired. The DBIPV structure 300 comprises a plurality of PV panels 114 and may be used where there are space and other limitations. For example, the DBIPV structure 300 may be attached to one or more parts of the structure 400 to provide for the installation of PV panels 114 where it was not possible before or where it is desired to increase the number PV panels 114 to increase the surface area.

Preferably, the PV panels 114 used with the DBIPV structure 300 may comprise thin and light and flexible sheets 116 of photovoltaic material (compared to more conventional stiff panels). The sheets 116 may also be translucent and may be shaped in various designs and shapes as desired. As most panels are of a set shape or design, it is possible that the sheets 116 be attached to a background layer which could generally be light and flexible or possibly at times less flexible to assist in the final design and outlook. The different and various designs may also be necessary when the DBIPV structures 300 are used in houses and/or locations where it is necessary to avoid any complaints or objections of the neighbors or the community. Those complaints could be similar to those when a solar farm is being built near a residential neighborhood or on agricultural land.

In time, the sheets 116 may be formed by spraying or painting photovoltaic cells on a background substrate.

The DBIPV structure 300 further comprises a DBIPV base 302 that houses the necessary mechanisms for operating the DBIPV structure 300. The DBIPV base 302 may be placed within a compartment within structure walls 402 of the structure 400 or in a compartment attached to the structure walls 402 of the structure 400. The DBIPV base 302 may use the same or different extension mechanism for deploying the various parts of the DBIPV structure 300 (compared to the solar tree base 102 and the solar vessel base 202). For example, the DBIPV base 302 may be extended generally horizontally from the structure walls 402 before being deployed vertically. In this manner, it may not be necessary to include a heavy base to anchor the DBIPV base 302 since it would be anchored to the structure walls 402.

Referring to FIGS. 20 to 25, the DBIPV structure 300 may take several forms, as shown as 300a to 300u.

The DBIPV structure 300 (see, for example, 300d) may further comprise a DBIPV stem 304 attached to the DBIPV base 302. The DBIPV stem 304 is analogous to the solar tree trunk 104 and the solar vessel mast 204. The DBIPV stem 304 may be telescoping (e.g. with the DBIPV stem 304 comprising a plurality of stem segments 330 that collapse within one another) and may have different mechanisms for deployment as it may be extending out of one of the structure walls 402. Alternatively, the stem segments 330 may be removably detached from each other (e.g. instead of being telescoping). The stem segments 330 may be of different sizes.

The DBIPV structure 300 further comprises one or more DBIPV fronds 306 attached to the DBIPV stem 304, which are analogous to the solar tree branches 106 and the solar vessel sails 206. Preferably, the DBIPV fronds 306 are hingedly or pivotably connected to the DBIPV stem 304. One or more of the PV panels 114 are attached to the DBIPV fronds 306. There may be differences in how the DBIPV fronds 306 are deployed (compared to the solar tree branches 106 and the solar vessel sails 206) in order to accommodate the deployment out of one of the structure walls 402. For example, it may be easier to deploy (i.e. open and/or close) a rectangular or square PV panel 114 when it is being housed in the structure wall 402 or in the structure 400 and being deployed outwardly (rather than vertically), as it would not necessarily need to be folded in tight conditions or have to be wrapped. Accordingly, the PV panels 114 in this embodiment may be less flexible than those used in the mobile solar tree 100 and the mobile solar vessel 200.

Moreover, as the DBIPV stem 304 is generally extended out of the structure wall 402 or the structure 400 itself, the DBIPV stem 304 may also be deployed at an angle so as to fan the DBIPV fronds 306 and allow the use of more DBIPV fronds 306 with perhaps different designs or in groups of smaller DBIPV fronds 306. They may be arranged so as to not be shadowed by one another as much as possible.

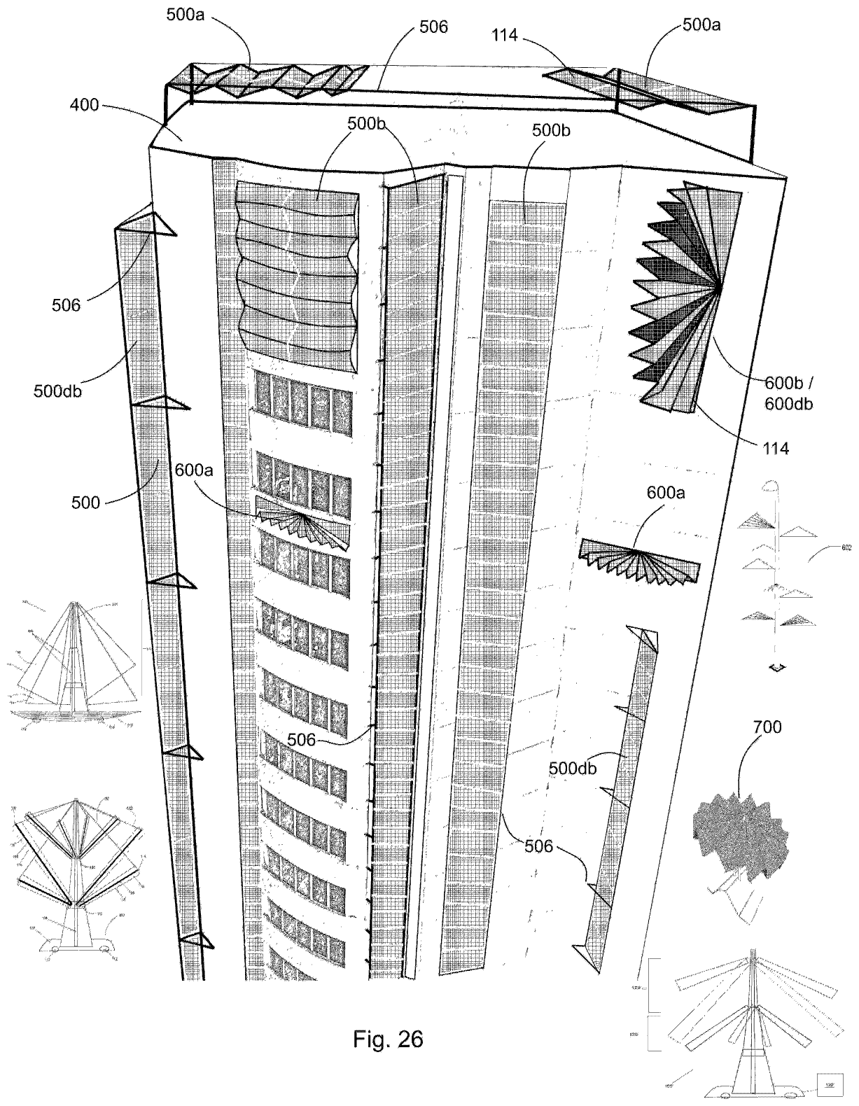

Referring to FIGS. 26 to 28, various embodiments of the DBIPV structure 300 are shown. These embodiments include floating solar clouds 500, dynamic building-integrated photovoltaics bellows (DBIPVB) 600, and solar tree bellows 700 and lamppost bellows 602. FIG. 26 depicts possible installations for these three embodiments in relation to a structure 400.

Both the floating solar clouds 500 and the DBIPVB 600 may be arranged in a horizontal and/or vertical configuration. Referring to FIG. 26, the floating solar cloud 500 may be in a horizontal (500a) or vertical (500b) configuration. Similarly, the DBIPVB 600 may be in a horizontal (600a) or vertical (600b) configuration. Other orientations for the floating solar clouds 500 and the DBIPVB 600 are also possible.

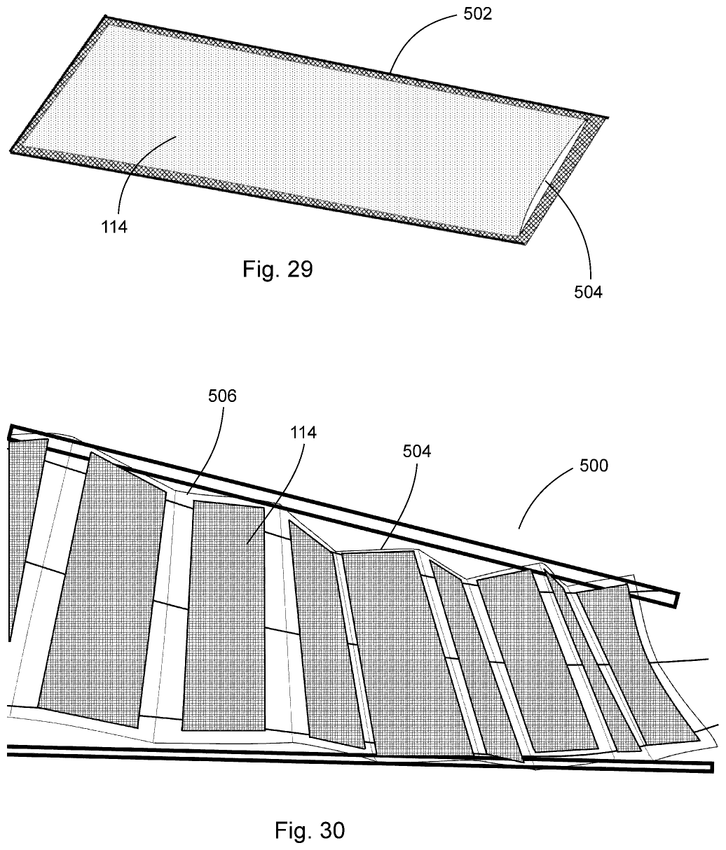

Referring to FIG. 29, the floating solar clouds 500 and the DBIPVB 600 comprise PV panels 114. The PV panels 114 may be in a double-sided back-to-back configuration for the vertical configurations (e.g. floating solar cloud 500b and DBIPVB 600b). Such double-sided configurations 500db and 600db of the PV panels 114 are formed by having two PV panels 114 fitted together back-to-back or installed or attached to a base layer 502 between the two PV panels 114. Furthermore, the two PV panels 114 may instead be inserted into a substantially transparent sleeve 504. By arranging the two PV panels 114 back-to-back, they can be used when both the front and back of the floating solar cloud 500 or the DBIPVB 600 are exposed to light. It is also possible to use such back-to-back configurations of the PV panels 114 for horizontal configurations of the floating solar cloud 500 or the DBIPVB 600 (i.e. 500a, 600a, respectively).

Referring again to FIG. 29, one or more of the PV panels 114 may be encased within the sleeve 504, which would have openings and pockets/fittings designed to accommodate any fittings or attachments used by the PV panels 114. As the PV panels 114 are typically thin and flexible, they may not always be properly or securely adhered to the base layer 502, resulting in the PV panels 114 peeling off after extended periods of time. This is especially the case where there is constant movement from wind and also when used at high temperatures. Moreover, deploying the PV panels 114 without the additional base layer 502 in those embodiments subject to heavy winds and stresses for extended periods could result in damage of the PV panels 114.

The sleeve 504 also helps with the ventilation of the PV panels 114 where some or most may become fairly hot in the process of generating the energy and even more so when used in warm climate locations. Inserting the PV panels 114 inside the sleeve 504 allows for better ventilation and also ensures that they are held in place safely. The sleeve 504 also assists when one of the PV panels 114 needs to be changed or replaced (especially when the PV panel 114 fails or new models are available with higher output or lower cost) or for maintenance. This can be done easily and quickly and without damaging the installations.

The sleeve 504 may also make it easier to manufacture a ready-to-use unit for export to anywhere without having to restrict the consumer to a specific panel manufacturer and allows the consumer to make the choice. This will also result in the possibility of buying the required solar installation from the appropriate hardware store to create all the energy required for a unit or a house or structure.

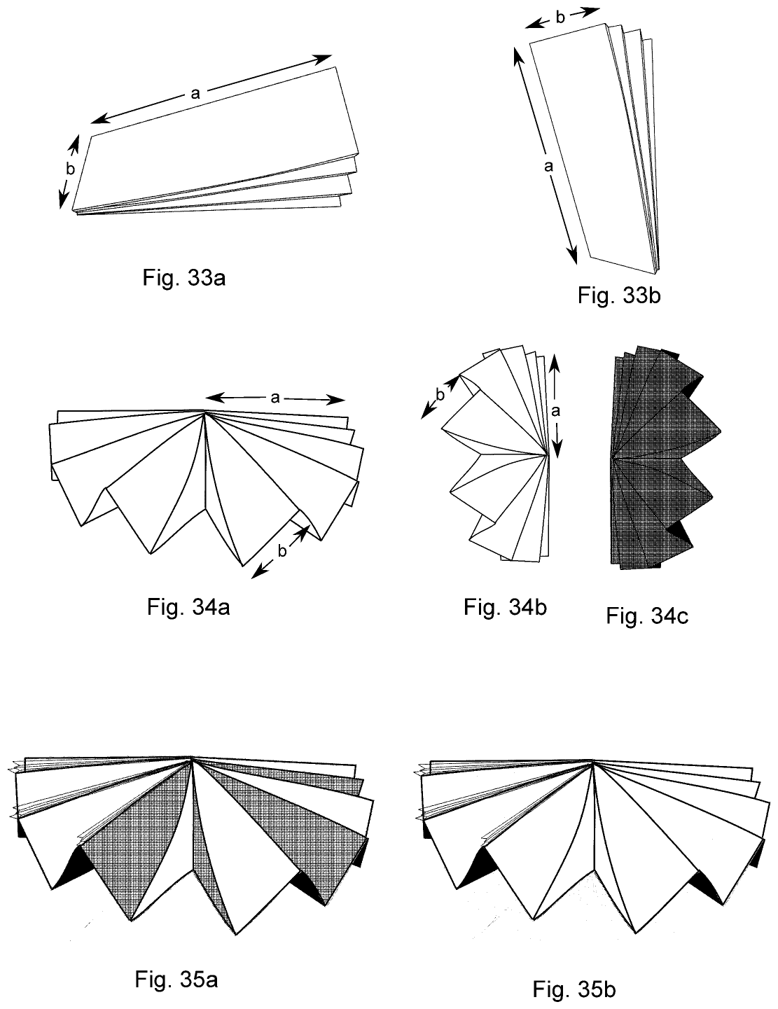

The sleeve 504 may generally be formed from a durable substantially clear top layer that allows light to pass through to allow the enclosed PV panels 114 to perform with maximum efficiency. The sleeve 504 may also instead comprise certain types of composite or/and netting fabric, while the base layer 502 may also be formed from a flexible and durable substrate such as those used for vehicle shades. The sleeve 504 may be manufactured individually (as shown in FIG. 29) and then connected together as required. Alternatively, the sleeve 504 may be formed to match the required length of the floating solar cloud 500 or also in long sheets as in FIGS. 30 to 32 for the floating solar cloud 500 and also FIGS. 33 to 51 for the DBIPVB 600 and the floating solar clouds 500.

The sleeve 504 may also be formed with a light frame of composite materials for extra strength or simply stitching or welding or other method of adhering the top clear/transparent layer to the base layer 502 in the required size to accommodate the PV panels 114 as well as any other connections and necessary attachments. It is contemplated that the floating solar clouds 500 and the sleeves 504 and all DBIPV embodiments could be sprayed with a PV ink/paint thus eliminating the use of any PV panels 114.

Referring to FIGS. 26 and 30 to 32, various possibilities for forming the floating solar clouds 500 are shown, both in horizontal/vertical configurations or any angles in between. The floating solar cloud 500 may be connected to supports 506, such as steel or composite plastic wires or cables or guides/rails, so that they could be opened and closed as and when required or closed to avoid inclement weather and similar techniques and technology described above for mobile solar tree 100 and the mobile solar vessel 200. These configurations may be used vertically and/or horizontally and may be stretched over large roofs or walls from appropriate supports to allow the PV panels 114 to be opened and closed as shown in the figures. Perforations or other cut-outs could be made in the bellows to allow for the wind to pass through and reduce the stresses on the PV panels 114. The floating solar cloud 500b shown in FIG. 26 could have double PV panels 114 fixed back-to-back when the floating solar cloud 500b are in such a position so that the light would be able to shine on both sides.

The horizontal/vertical opening and closing mechanisms as shown in FIGS. 30 to 32 use supports 506 to open and close the floating solar cloud 500 as and when required. Other methods are also possible for both manual and mechanical operation (e.g. similar to how awnings are extended to shade areas).

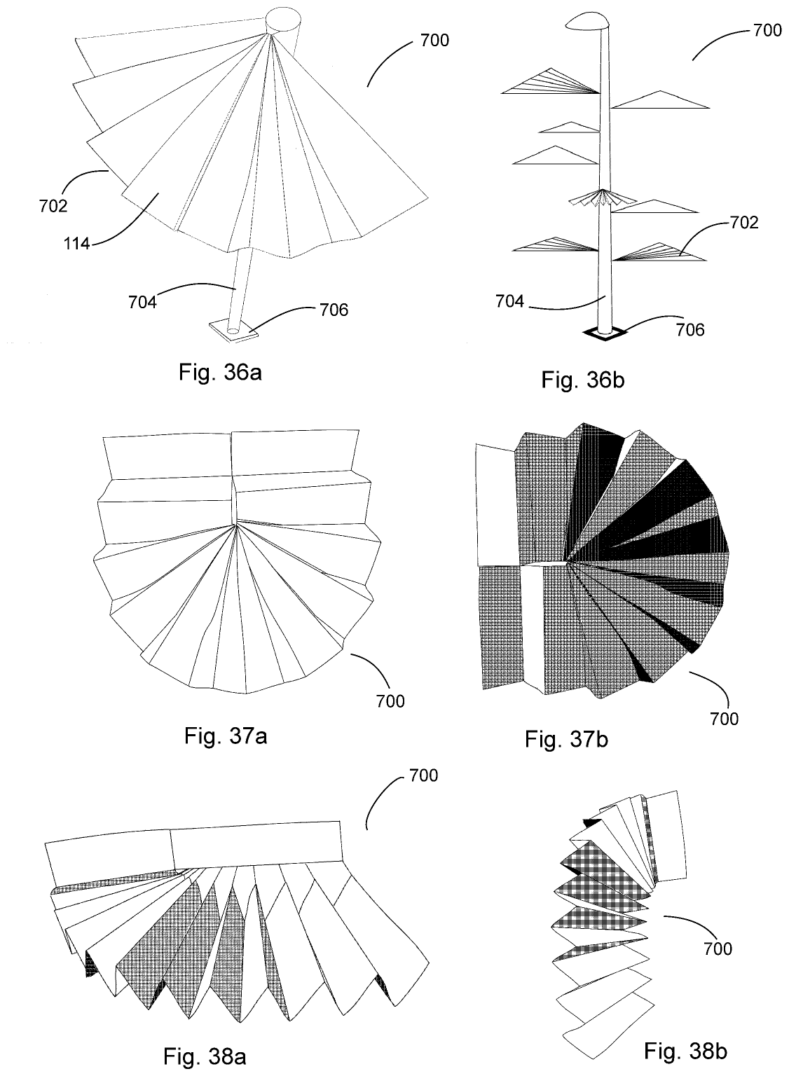

With respect to the DBIPVB 600, many configurations and embodiments are possible, including horizontal and vertical configurations that may be installed over windows in a building to provide shade and energy. They may also be fixed or closeable. One such embodiment is shown in FIG. 36, which shows an embodiment of the DBIPVB 600 attached to a lamppost 602. It is also possible to have more than one of the DBIPVB 600 installed on the lamppost 602. In addition, storage batteries and software programs (e.g. similar to those used for opening and closing as the mobile solar tree 100 and the mobile solar vessel 200) may also be included.

FIGS. 33 to 35 show rectangular embodiments of the PV panels 114 of the DBIPVB 600 with a width (b) and a length of (a). When the length (a) is 2 m, and the width (b) is 1 m, then the area of each of the PV panel 114 would be 2 m², which is the area it occupies on the wall when closed. Therefore, with a 20-leaf DBIPVB 600 containing 20 PV panels 114 fitted, the total PV area would be a total area of 40 m². However, when it is opened, it would only occupy or require an area of 4 m² of wall (either vertically or horizontally). Thus, by using thin, light, and flexible PV panels 114 at 3.5 kg/m² (the PV panels 114 may have a weight ranging from 0.3 kg/m² to 3.5 kg/m² each), the DBIPVB 600 may have a total weight of about 80 kg to 160 kg (including the sleeve materials, if any) and may easily be loaded onto any wall or structure. This would allow a 2 m² area of a wall or part of a building or structure to expand into a solar panel space more than 10 times its area. Therefore, this would allow almost any buildings/houses or structures to be able to have sufficient solar panels installed to power the structure without having to worry about where they could find the space to deploy the solar panels or how to deploy them.

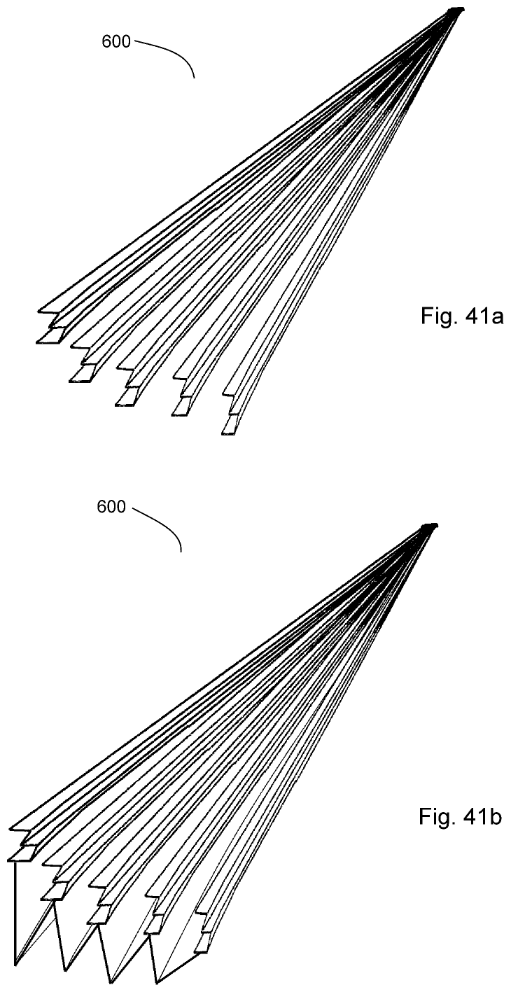

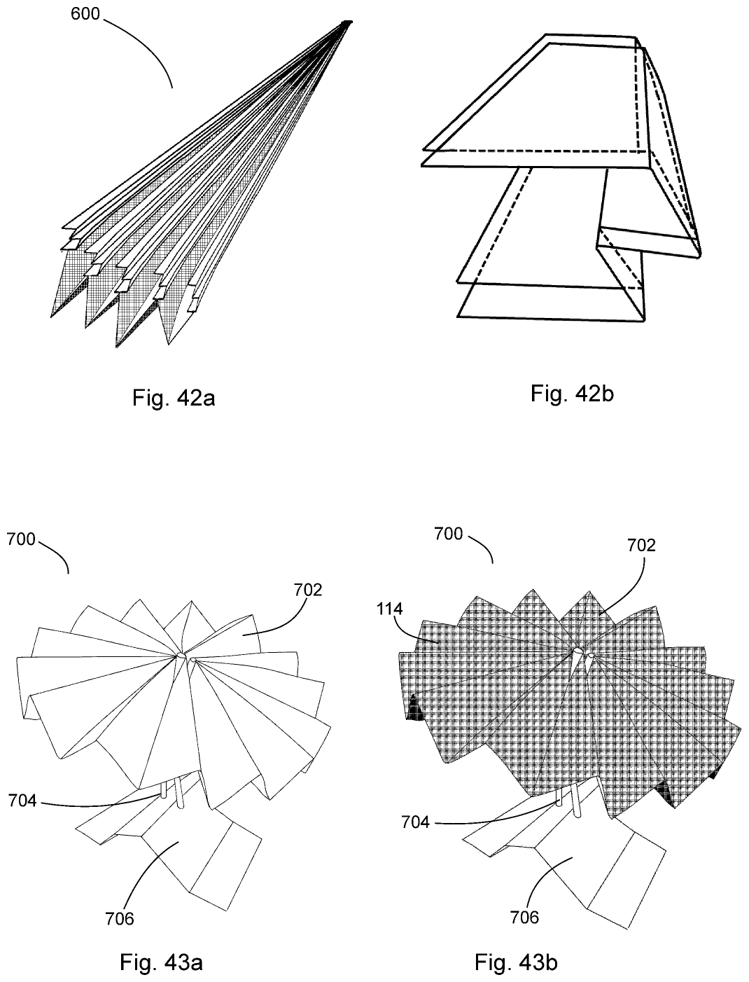

Moreover, when the DBIPVB 600 is closed, the PV panels 114 pack up to a box size with an area of just 2 m² and would be hardly noticeable, as the thickness would be relatively small due to the fact that the PV panels 114 are only a few millimeters thick (including the sleeve material, if any). If Z-Arch channels (as described in U.S. Pat. No. 10,240,334 to Paulus, the contents of which are hereby incorporated by reference) are used to launch and support the PV panels as shown in FIGS. 35, 38 to 42, and 48 to 50, then they would stack up into each other as shown in FIGS. 42a and 42b. The PV panels 114 may be fitted into the sleeve 504, which could be fitted into a continuous base fabric and/or could have a light metal or metal/composite frame to help with the support or deployment or have steel wires or other types of high-tension cords to open and close or deploy the panels. Furthermore, this bellows and sleeves method may also be used with the mobile solar tree 100 and the mobile solar vessel 200.

Additionally, the size and shape of the DBIPVB 600 may be changed, and the number of PV panels 114 increased or decreased as desired. For example, FIGS. 37 and 38 show the DBIPVB 600 extended or deployed vertically in a different style. These configurations could be used vertically and/or horizontally.

FIGS. 38 to 40 show embodiments of the DBIPVB 600 where the PV panels 114 are shorter than the Z-Arch channels. This may allow air and wind to pass through while also avoiding having the PV panels 114 proximate to the ends of the DBIPVB 600 have creases to make more use of the exposure of the PV panels 114.

Preferably, the DBIPVB 600 would generally be installed at an angle greater than 45 degrees to the horizontal. This would enable the PV panels 114 to get almost as much exposure to the sun as when then PV panels 114 are arranged horizontally flat, and the angle could be brought closer to the horizontal by spreading the individual bellows of DBIPVB 600 wider or differently (e.g. as shown in FIGS. 38 to 40) and also by changing the size of the length (a) and/or the width (b), as shown in FIG. 33.

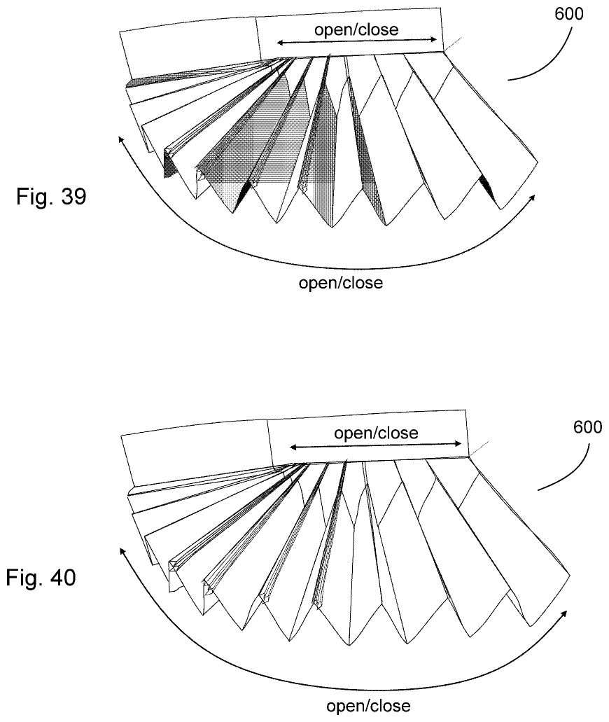

The indicative opening and closing mechanisms for the DBIPVB 600 is shown in FIGS. 39 to 40 and 48 to 50. The DBIPVB 600 is opened and closed using a channel at the top to provide the strength and support. There are many opening and closing mechanisms possible, both manual and automatic. For example, the Z-Arch channel may be used, as it can fit into each other when closed for compactness and also has high strength when opened. The DBIPVB 600 may be manufactured in the form of a box, with the Z-Arch channels and sleeves ready. The top front cover of the box would open and attach to the wall when totally open, while the bottom back end of the box could be a frame or anchored to the wall or structure and would not move. The PV panels 114 may be added in the box at this time or at some later time. Other types of channels or supports besides the Z Arch channels may also be used.

The thickness and weight of the box unit will depend on the size and number of PV panels 114 and may be made of composite plastics for strength and light weight. The sleeves 504 with the PV panels 114 may have an average thickness of 5 to 7 mm. Therefore, a 20-panel box of 2 m² may be around 20 cm thick, while the weight would vary depending on the number of PV panels 114 inserted. They may be inserted after the box is fitted on the wall or structure, which would make the installation much easier.

Many current materials used for PV panels 114 may pose environmental problems as they are difficult to recycle. Better in this regard are the OPV (organic photovoltaic) materials, but these still have low efficiency and are more costly. Panels made from silicon fiberglass are one new type with high efficiency and lower cost and are more environmentally friendly, providing about 170 watts per m² per hour with a weight of 3.5 kg/m². A single PV panel 114 with the area of 2 m² (1 m×2 m) would give an output of approximately 340 w/m/hr and when attached to the DIPVB 600 of 20 panels, they would have a total output of 6,800 W/hr, which is sufficient to power 3 two-bedroom 150 m² apartments with a three-bedroom dwelling of around 350 m², especially in sunny locations such as California.

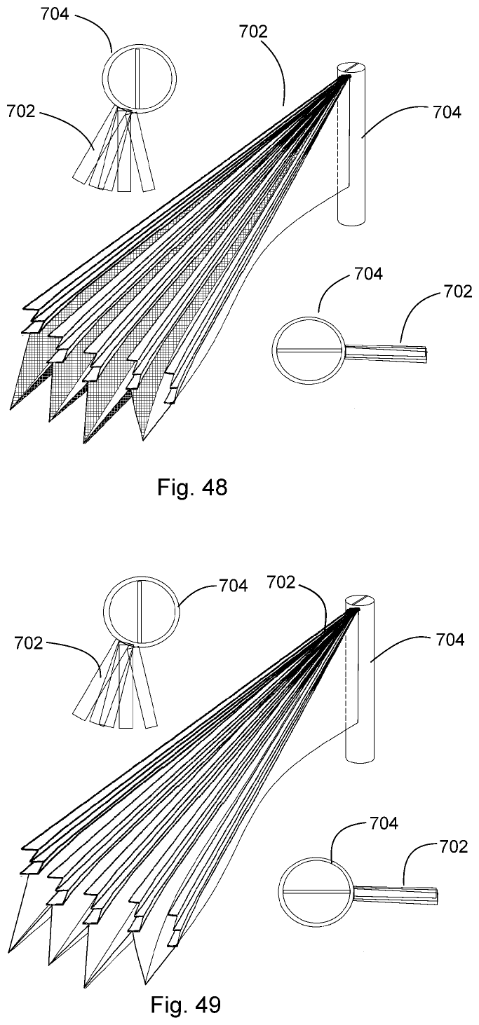

FIGS. 43 to 47 show embodiments of the solar tree bellows 700 where the top comprises a full circular bellows 702 raised on a bellows stem 704 with a bellows base 706. The solar tree bellows 700 is similar in description and details to the DBIPVB 600 when open but with a full circular effect. The bellows base 706 and bellows stem 704 shown in FIGS. 43 and 45 are indicative and may be similar to the mobile solar tree 100. Alternatively, it may be modified where the bellows stem 704 is composed of two concentric cylinders one inside the other (as shown in FIGS. 48 to 50), or even outside each next to the other as in FIGS. 43-46 to support the weight of the circular bellows 702. The bellows base 706 may be as shown or a have a multitude of other designs. It may also have mobility as in the mobile solar tree 100.

Referring to FIG. 43, the circular bellows 702 of the solar tree bellows 700 preferably close downwards and inwards, as shown in FIGS. 48 to 50. FIG. 45 shows the solar tree bellows 700 in the final stages of closing. The solar tree bellows 700 may also be closed flat similar to the DBIPVB 600 and may resemble the shape shown in FIGS. 29 or 33b or 46c and 46d, but with the bellows stem 704 in the center. Many other closing and opening designs are possible, both manual and automatic.

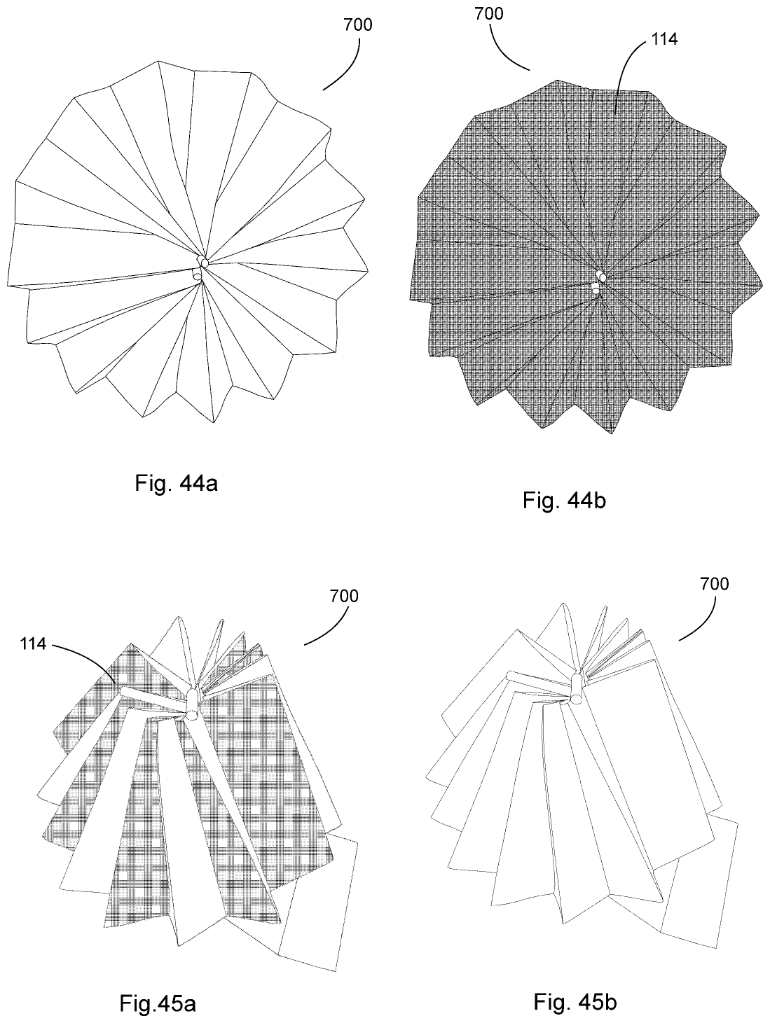

The energy calculation for the solar tree bellows 700 is similar to that for the DBIPVB 600 but with a higher output as the solar tree bellows 700 would typically be larger. Similar various and alternative configurations can be adopted here as in the case with the DBIPVB 600. As an example, FIGS. 43 and 44 show a solar tree bellows 700 with 28 leaves. If each leaf is approximately 2 m² in surface area, then the total area of the PV panels 114 would be approximately 56 m². Where the PV panels 114 have an output of 340 w/m/hr each, the solar tree bellows 700 may produce approximately 19,040 w/hr, which is almost 3 times the energy produced by the DBIPVB 600 shown above and may power around 11 units with an area of about 150 m² each (such as two-bedroom apartment/houses including air conditioning). The solar tree bellows 700 may only require a footprint of 16 m² above ground level, at the dimensions of 4 m×4 m bellows, but could occupy only 4 m² of ground for a base or maybe even less. This could constitute a saving of over 82.3% of land in comparison to the traditional ground-mounted PV panel systems, which would occupy more than 16 square meters, with a PV area of only 16 square meters to allow for distances between panels.

Where the DBIPVB 600 is installed in conjunction with the lamppost 602, such arrangements may have a fairly large power output, especially when installed on lampposts 602 that are tall, with the PV panels 114 arranged with many layers and staggered configurations, as shown in FIG. 36b. The lampposts 602 may be fixed, mobile, or transportable. Those bellows may have different colours on the bottom layer, which is what is usually seen from the street level so they can be used to add a colourful and joyous mood as well as advertising to generate revenues. This may be useful in locations such as Africa or other remote locations where there is an abundance of sunshine but electricity is hard to find. Alternatively, they may be used to quickly power communities after hurricanes down the power lines. This is also a novel solution, where now solar panels could be installed anywhere on and around a building and not only on the roof to satisfy the California building code.

It is also possible to add wind turbines to the solar tree bellows 700, thus turning the solar tree bellows 700 into a wind power generator when wind is available.

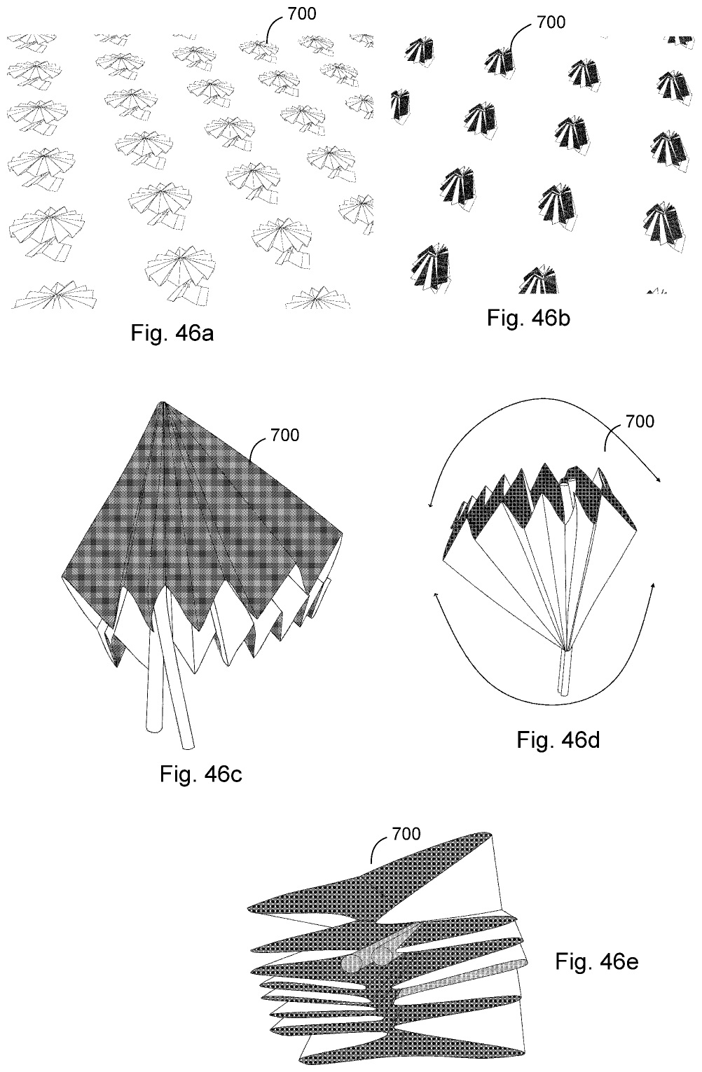

The solar tree bellows 700 and the floating solar clouds 500 may be installed on poles and opened to a longitudinal or circular embodiment to shade agricultural land or other grounds and also to generate energy on buildings with large rooftop areas, such as warehouses and shopping malls. It is also possible to use them on agricultural land as it frees up the land below and shades it or to help with deforestation and/or desertification. They may also be used to protect rainforests when deployed above the trees, as shown in FIGS. 46, 47, and 51, They may be closed when necessary or during inclement weather or even packed and stowed away before the onset of storms or hurricanes. They can then be opened and deployed after the storm to generate electricity with little delay.

The embodiments of the DBIPV 300 (i.e. the floating solar cloud 500, the DBIPVB 600, and the solar tree bellows 700) may be used in both the vertical and horizontal configurations when the constituent PV panels 114 have sufficient transparency and also in the multilayered embodiment.

In another embodiment, a water sprinkler system may be incorporated to clean the PV panels 114 when necessary. The water sprinkler system may also act as a fire extinguishing system should there be such a need, as PV panels 114 have the possibility of overheating or catching fire. Other firefighting systems/methods could be used as well.

Yet another embodiment is the use of the DBIPV 300 in a system to prevent forest fires or help to quell them where the DBIPV elements would be deployed in a network of solar trees/sails and other DBIPVs 300 spread over a large area in and around a forest connected in a grid with sensors preferably in a wireless mode or via satellite to detect and prevent forest fires. The DBIPV 300 would supply power to the system and to a connected network of pumps to draw water from a network of canals and/or reservoirs and/or from ground water to moisten the grounds when they become too dry to prevent the fires or to quell the fires or manage them should they start. This system can also work with a network of canals acting as a firewall or a series of firewalls designed to stop or prevent the fire from spreading. The sensors in the system, both in the DBIPV 300 and/or outside them could be programmed to detect when the earth/plants become too dry to moisten them to prevent the fires or/and detect forest fires as early as possible and activate the system to fight the fire quickly and prevent it from spreading. This can be made possible due to the portability of the solar tree/sails and other DBIPV, which could be moved and located at various positions to help power the sensors and the pumps which otherwise would be impossible or very difficult due to the vast areas of most forests worldwide and this could be a timely solution to the Californian and Australian forest fires as well as others in Europe, Asia and South America and other parts of the world.

It will be appreciated by those skilled in the art that the preferred embodiment has been described in some detail but that certain modifications may be practiced without departing from the principles of the invention.

1. A mobile apparatus for converting solar energy to electrical energy, the mobile apparatus comprising:
a base;
a central trunk extending from the base, wherein the central trunk comprises an outer wall, wherein the outer wall comprises a plurality of wall segments, wherein the wall segments are configured to telescope within one another;
one or more branches connected to the central trunk; and
one or more photovoltaic panels connected to the one or more branches, wherein the photovoltaic panels comprise one or more sheets of photovoltaic material and one or more anchors for attaching the sheets of photovoltaic material to the branches,
wherein the branches are configured to be movable with respect to the central trunk.

2. (canceled)

3. (canceled)

4. (canceled)

5. (canceled)

6. (canceled)

7. (canceled)

8. The mobile apparatus of claim 1 further comprising one or more deployment cables extending between the central trunk and one or more of the branches.

9. The mobile apparatus of claim 1 further comprising a motorized mechanism for moving the branches with respect to the central trunk.

10. The mobile apparatus of claim 1, wherein the central trunk further comprises a central reinforcement rod, wherein the central reinforcement rod is configured to be telescoping.

11. The mobile apparatus of claim 1, wherein the sheets of photovoltaic material are substantially flexible.

12. (canceled)

13. (canceled)

14. The mobile apparatus of claim 1, further comprising one or more sleeves, wherein each sleeve is configured to hold one or more of the one or more photovoltaic panels.

15. The mobile apparatus of claim 1, wherein the branches are configured to be foldable such that the photovoltaic panels form one or more bellows.

16. The mobile apparatus of claim 1 further comprising a security system connected to one or more of the base, central trunk, or branches.

17. The mobile apparatus of claim 1, wherein the base is substantially hollow.

18. The mobile apparatus of claim 1 further comprising a weather system, wherein the weather system effects the movement of the branches based, at least in part, on the weather.

19. The mobile apparatus of claim 1 further comprising one or more wind turbines for generating electricity from wind power.

20. (canceled)

21. (canceled)

22. An apparatus for converting solar energy into electrical energy for use with a structure, the apparatus comprising:
a base attached to a structure;
a central stem extending from the base, wherein the central trunk comprises an outer wall, wherein the outer wall comprises a plurality of wall segments, wherein the wall segments are configured to telescope within one another;
one or more fronds connected to the central stem; and
one or more photovoltaic panels connected to the one or more fronds, wherein the photovoltaic panels comprise one or more sheets of photovoltaic material and one or more anchors for attaching the sheets of photovoltaic material to the fronds;
wherein the fronds are configured to be movable with respect to the central stem.

23. (canceled)

24. (canceled)

25. (canceled)

26. (canceled)

27. An apparatus for converting solar energy to electrical energy, the apparatus comprising:
a base;
a central trunk or stem extending from the base, wherein the central trunk comprises an outer wall, wherein the outer wall comprises a plurality of wall segments, wherein the wall segments are configured to telescope within one another;
multiple branches connected to the central trunk or stem, wherein at least a first branch comprises one or more solar units, in particularly photovoltaic panels, and wherein a second branch comprises one or more solar units, in particularly photovoltaic panels, wherein each of the solar units of the first branch comprises one or more sheets of photovoltaic material and one or more anchors for attaching the sheets of photovoltaic material to the first branch, and
wherein each of the solar units of the second branch comprises one or more sheets of photovoltaic material and one or more anchors for attaching the sheets of photovoltaic material to the second branch, wherein the first branch is coupled via a first joint to the central trunk or stem to be movable with respect to the central trunk or stem,
and
wherein the second branch is coupled via a second joint to the central trunk or stem to be movable with respect to the central trunk or stem.

28. (canceled)

29. (canceled)

30. (canceled)

31. (canceled)

32. (canceled)

33. The apparatus of claim 27, further comprising at least two deployment cables extending between the central trunk and two branches, in particularly the first branch and the second branch, wherein one deployment cable connects an upper section of the central trunk or stem with an axial end of one branch and wherein the other deployment cable connects the upper section of the central trunk or stem with an axial end of the other branch, wherein the upper section is materialized on one side of the upper part and wherein the lower part is materialized on the other side of the upper part.

34. The apparatus of claim 27, further comprising a motorized mechanism for moving the branches with respect to the central trunk, wherein an actuator is connected to one or multiple or all of the deployment cables, wherein the actuator moves one or multiple or all deployment cables in response to an operation of an motor, wherein the motor is arranged at the central trunk or stem or on or in the base.

35. The apparatus of claim 27, wherein the central trunk or stem further comprises a central reinforcement rod, wherein the central reinforcement rod is configured to be telescoping.

36. (canceled)

37. (canceled)

38. (canceled)

39. The apparatus of claim 27, further comprising one or more sleeves, wherein each sleeve is configured to hold one or more of the one or more photovoltaic panels, wherein at least one sleeve is attached to the first branch and wherein another sleeve or the same sleeve is attached to another branch, in particular the second branch or a third branch.

40. (canceled)

41. (canceled)

42. (canceled)

43. The apparatus of claim 34, further comprising a weather system, wherein the weather system effects the movement of the branches based, at least in part, on the weather, wherein the weather system comprises at least one sensor unit, wherein the sensor unit comprises at least a wind sensor and/or a heat sensor and/or a light sensor and/or fire sensor or smoke detector and/or a motion sensor, in particular an acceleration sensor, in particular a multi axis acceleration sensor, in particular a three axis acceleration sensor, wherein the sensor unit is arranged at the central trunk or stem or at the base or at one of the branches, and wherein the apparatus comprises a control unit, wherein the control unit processes the sensor data of the at least one sensor unit and operates the motor to move at least one deployment cable.

44. The apparatus of claim 34, further comprising an actuator for rotating the central trunk or stem, wherein said actuator is arranged at the central trunk or stem and/or at the base, wherein the actuator is coupled with the motor or with another motor, wherein the control unit operates the motor or the other motor to actuate the actuator for rotating the central trunk or stem in dependency of the sensor data.

45. The apparatus of claim 27, further comprising one or more wind turbines for generating electricity from wind power, wherein the one or more wind turbines are arranged on the base on or below the branches.

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)
